(19) United States
(12) Patent Application Publication
(10) Pub. No.: US 2015/0034023 A1
(43) Pub. Date: Feb. 5, 2015

(54) Dog Excrement Collector

(71) Applicant: TIEN SZU TSENG, Taichung City (TW)

(72) Inventor: TIEN SZU TSENG, Taichung City (TW)

(73) Assignees: CHIN FA CHANG, Changhua County (TW); TIEN SZU TSENG, Taichung City (TW)

(21) Appl. No.: 14/449,164

(22) Filed: Aug. 1, 2014

(30) Foreign Application Priority Data
Aug. 2, 2013 (TW) 102127719
Jul. 11, 2014 (TW) 103123874

(51) Int. Cl. A01K 23/00

(52) U.S. Cl. CPC A01K 23/00
USPC 119/868

(57) ABSTRACT

A dog excrement collector includes a wearable toilet adapted for being worn by a dog, and a pouch including a bag body detachably held by said wearable toile. The wearable toilet has a pad through window arranged for being aligned with an anus of the dog when the dog wears the wearable toilet. The bag body has an inlet aligned with the pad through window for receiving and collecting dog's droppings in the bag body by gravity. Therefore, after the dog's droppings are collected, the bag body is detached from the wearable toilet and is sealed at the inlet.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

This invention relates to dog accessories, and more particular to a dog excrement collector adapted for being worn by a dog, wherein a bag body is hidden during the normal activities of the dog and is arranged for receiving and collecting dog's dropping, so as to help the dog owner to handle dog droppings easily and conveniently.

2. Description of Related Arts

Please refer to the utility model patent of “Excrement Collection Device,” Taiwan Patent 097207859 (hereafter, the first prior case); it describes a device for picking up dog droppings, which is a device having a function of picking up the dog droppings after they have fallen on the ground. The device has a weakness that it cannot pick up soft excrement or still leave besmearing on the ground, and an inconvenience that one must carry an excrement collection device when he or she is out for dog walking.

Please refer to the utility model patent of “Pet Excrement Picker (temporary translation),” Taiwan Patent 099209254 (hereafter, the second prior case); it is an invention for solving dog dropping picking issue caused by having dog in the urban. It is improved in comparing with the first prior case that it holds dog droppings in the air before the dog droppings fall on the ground, which has improved the disadvantage of the first prior case that the soft excrement cannot be picked up and besmearing can be left on the ground. However, this prior invention is still inconvenient because its user still needs to carry it during dog walking and constantly watch if the dog is going to defecates, and therefore couldn't walk dogs in a free and relaxed mood.

Please refer to the utility model patent of “Animal Excrement Collector (temporary translation),” Taiwan Patent 096106123 (hereafter, the third prior case). Based on the fourth figure of the third prior case, it is also an invention for solving dog dropping picking issue caused by having dog in the urban. The difference between this case and the previous two cases is that this invention directly wears the collector for receiving dog droppings on the dog, so that the owner doesn't have to further carry an excrement picker, which solved the issue of inconvenience of carrying. Although this prior invention still requires the finishing of simple wearing steps of putting the collector on the dog, however these steps of wearing can certainly be finished before the owner going out for dog walk. During the dog walking, the owner's mood wouldn't be affected by paying attention to when the dog is going to defecate, so he can relaxingly enjoy the pleasure of dog walking and certainly take the dog droppings without having the issue of the first prior case that soft excrement cannot be picked up or besmearing is left on the ground, and the inconvenience of the second prior case that an additional excrement picker has be carried with. Therefore this prior invention could be a design suitable for keeping dog in the urban. Nevertheless it has a weakness of unpleasant appearance; referring to the fourth figure of this prior case, its plastic bag 4 is to effectively receive dog droppings and therefore should keep an inflated shape and hang on the dog's hip before the dog defecates, which looks weird and inartistic. Beautiful shape of dog itself was harmed, and therefore such invention needs further improvement.

Please refer to the utility model patent of “Pouch, Urinal, and Toilet for Connecting Pouch and Urinal for Receiving Animal Discharges and Gear for Connecting Toilet (temporary translation),” Taiwan Patent 099209254 (hereafter, the fourth prior case); this is a prior invention invented by the current inventor, which filing date is prior to it of the third prior case. The idea of this prior invention was also to allow the dog owner to not necessarily leash a dog with one hand and hold an excrement picker of the first prior case or an excrement collector of the second prior case with another hand. Meanwhile, this prior design also considered not affecting the dog's normal activities before it defecates, which allows the dog to normally sit, stand, or grovel when it wears the fourth prior case. It also considered not harming the complete shape of the dog, so the toilet and pouch of this prior case are both flat design that the pouch was stored in the toilet and can only be pushed to open when the dog defecates. Unfortunately, it was found after practices that the structure of such pouch would have an unsolvable technical issue of drafting failure when it applies plastic material with machinery automated production. Pouch made by blow molding would expand an axial width due to its plasticity, which could not be folded to become a flat configuration like paper made pouch. However, if the pouch was to be made with paper, there was no ready-made automated equipment to produce it; therefore the only way was to complete it with manual processing, which caused a high cost of it and could not guarantee its waterproofing. Hence this prior invention still needs a further improvement.

### SUMMARY OF THE PRESENT INVENTION

Referring to the defects of the above prior cases, the current inventor, based on his wish of benefiting the society, has focused on conducting researches and experimented by producing samples. After many times of tests and improvements, the present invention that achieves the following goals of invention has finally been produced.

That is, the main object of the present invention is to allow dog owners to conveniently and easily handle dog droppings with the wearable toilet worn on the dog which is able to receive and store dog droppings by the time dog defecates, so that avoid the inconvenience that the owner had to collect the dog droppings on the ground.

Another object of the present invention is to use the magnetic attachment between a second magnetic film attached on a covering member and a first magnetic film affixedly attached on a junction of a pad body to limit the folded pouch in between the junction and the covering member without deploying, so as to allow the dog that is wearing the dog excrement collector to still be able to sit, stand, or grovel normally and remain beautiful shape of a dog without weird appearance. Meanwhile, when the dog defecates, the gravity of the dog dropping that is greater than the magnetic attraction between the first magnetic film and the second magnetic film is used to have the covering member be forced to pushed, so as to let the pouch naturally drop to deploy, which also exactly allow the dog droppings to enter and store in the pouch.

Another object of the present invention is to design the pouch retention frame that is used for securing pouches reusable, so as to reduce the total amount of discarded bags that have received dog droppings, and, as the bag bodies that have received dog droppings are going to be reprocessed into organic fertilizer or put into biogas generator to produce power, these bodies can be composed with simpler components and easier to be further reused.

Additional advantages and features of the invention will become apparent from the description which follows, and may be realized by means of the instrumentalities and combinations particular point out in the appended claims.

According to the present invention, the foregoing and other objects and advantages are attained by a dog excrement collector comprising a wearable toilet and a pouch.

The wearable toilet is adapted for being worn by the dog, wherein the wearable toilet has a pad through window arranged for being aligned with an anus of the dog. The wearable toilet comprising a pad body defining the pad through window thereat, one or more carrying belts extended from the pad body for being carried by the dog, and a covering member, having a top rim affixed to the pad body and a bottom rim serving as a free edge, for covering the pad through window and for retaining the bag body between the covering member and the pad body, wherein the wearable toilet further comprises a first magnetic film provided at the free edge of the covering member and a second magnetic film provided at the pad body to magnetically engage with the first magnetic film, so as to retain the covering member to cover at the pad through window

The pouch comprises a bag body detachably held by the wearable toilet, wherein the bag body has an inlet aligned with the pad through window for receiving and collecting dog's droppings in the bag body by gravity, such that the bag body is detached from the wearable toilet and is sealed at the inlet after the dog's droppings are collected. The pouch further comprises a pouch retention frame having a pouch through hole and affixed to the bag body to align the inlet of the bag body with the pouch through hole, wherein the pouch retention frame is detachably coupled at the pad body to detachably retain the bag body between the pad body and the covering member.

The bag body further has two pouch extending portions opposedly extended from the inlet of bag body, wherein the pouch extending portions of the bag body are adhered to the pouch retention frame to ensure the pouch through hole to be aligned with the inlet of the bag body.

Alternatively, the pouch retention frame comprises two foldable pressing buckles being pivotally folded to clip at the pouch extending portions, so as to ensure the pouch through hole to be aligned with the inlet of the bag body.

The wearable toilet is able to be directly toggled at the dog's neck or only crossly connected at the dog's butt with one or more carrying belts that can connect to the collar, harness, or clothing worn on the dog. As a result, the pad body is located at the dog's butt, wherein the pad through window of the pad body, the pouch through hole of the pouch retention frame, and the inlet of the bag body are aligned with the dog's anus. With magnetic attraction between the second magnetic film on the covering member and the first magnetic film of the junction of the pad body, the covering member limits the folded bag body from deploying in between the junction and covering member, so that the covering member will not detach from the junction whether the dog is sitting, standing, groveling, or running. Besides, when the dog defecates, the covering member will be forced to unfold by the gravity and pushing force of the dog dropping than the magnetic attraction between the first magnetic film and the second magnetic film. As a result, the bag body will be unfolded to push at the covering member, which also exactly allows the dog droppings to enter and store in the bag body.

### BRIEF DESCRIPTION OF THE DRAWINGS

FIG. 1 is an exploded perspective view of a wearable toilet of a dog excrement collector according to a first preferred embodiment of the present invention.

FIG. 2 is a perspective view the wearable toile of the dog excrement collector according to the first preferred embodiment of the present invention.

FIG. 3 is an exploded perspective view of the wearable toilet of the dog excrement collector according to the first preferred embodiment of the present invention.

FIG. 4 and FIG. 5 illustrate the assembling of the pouch of the dog excrement collector according to the first preferred embodiment of the present invention.

FIG. 6 is a perspective view the dog excrement collector according to the first preferred embodiment of the present invention, illustrating the folded pouch.

FIGS. 7, 8, and 9 are schematic diagrams illustrating the assembling of the dog excrement collector according to the first preferred embodiment of the present invention.

FIG. 10 illustrates the dog excrement collector being worn by a dog according to the first preferred embodiment of the present invention.

FIGS. 11 12, 13, and 14 are schematic diagrams illustrating the method of collecting dog droppings by the dog excrement collector being worn by a dog according to the first preferred embodiment of the present invention.

FIGS. 15 and 16 are schematic diagrams of sealing the pouch that has received dog droppings, of the dog excrement collector being worn by a dog according to the first preferred embodiment of the present invention.

FIG. 17 illustrates an alternative mode of wearing the dog excrement collector being worn by a dog according to the first preferred embodiment of the present invention, illustrating the dog excrement collector incorporating with the dog collar.

FIG. 18 illustrates an alternative mode of wearing the dog excrement collector being worn by a dog according to the first preferred embodiment of the present invention, illustrating the dog excrement collector incorporating with the dog garment.

FIG. 19 illustrates an alternative mode of wearing the dog excrement collector being worn by a dog according to the first preferred embodiment of the present invention, illustrating the dog excrement collector incorporating with the dog harness.

FIG. 20 is an exploded perspective view of a wearable toilet of a dog excrement collector according to a second preferred embodiment of the present invention.

FIG. 21 is a perspective view of the wearable toile of the dog excrement collector according to the second preferred embodiment of the present invention.

FIG. 22 is a perspective view of the wearable toile of the dog excrement collector according to the second preferred embodiment of the present invention, illustrating the covering member being folded outwardly.

FIGS. 23 to 25 illustrate the assembling operations of the pouch of the dog excrement collector according to the second preferred embodiment of the present invention.

FIGS. 26 to 29 illustrate the folding operation of the bag body of the dog excrement collector according to the second preferred embodiment of the present invention.

FIG. 30 is a side sectional view of the pouch of the dog excrement collector according to the second preferred embodiment of the present invention.

FIGS. 31 to 33 illustrate the operations of the dog excrement collector according to the second preferred embodiment of the present invention.

FIG. 34 illustrates the dog excrement collector being worn by a dog according to the second preferred embodiment of the present invention.

FIGS. 35 to 38 are schematic diagrams illustrating the method of collecting dog droppings by the dog excrement collector being worn by a dog according to the second preferred embodiment of the present invention.

FIGS. 39 to 42 are schematic diagrams of sealing the pouch that has received dog droppings, of the dog excrement collector being worn by a dog according to the second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

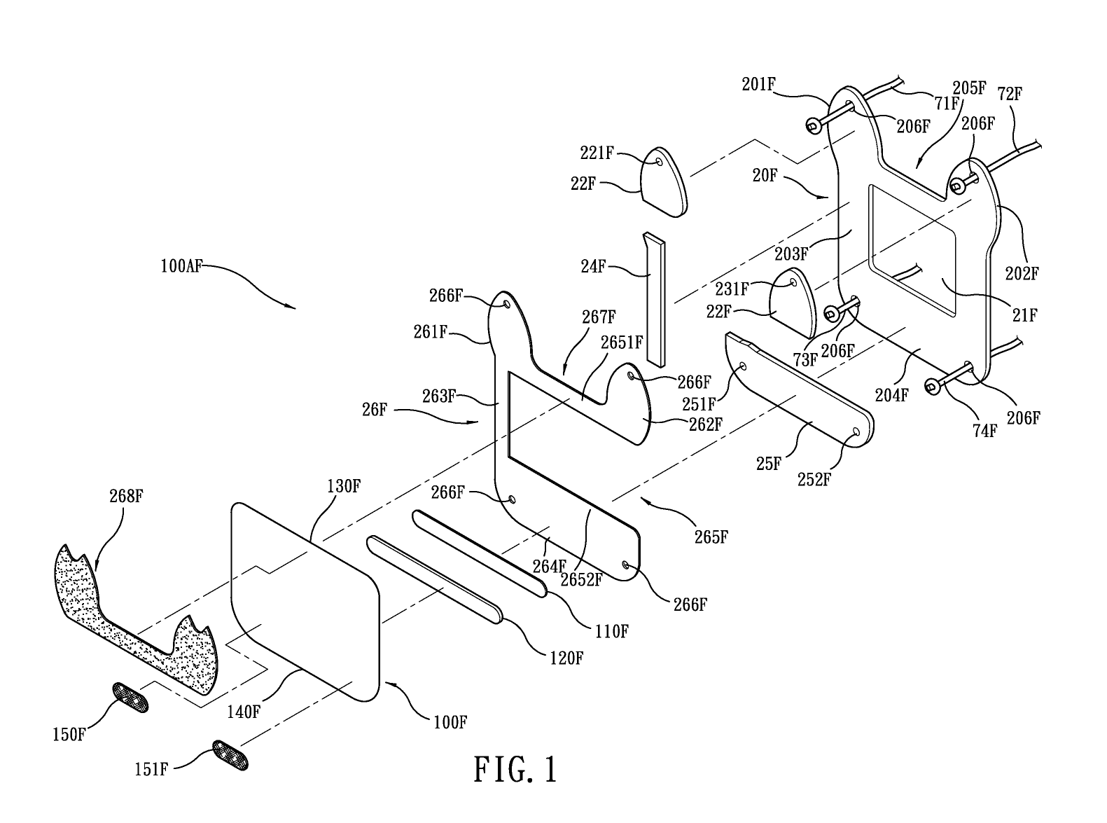

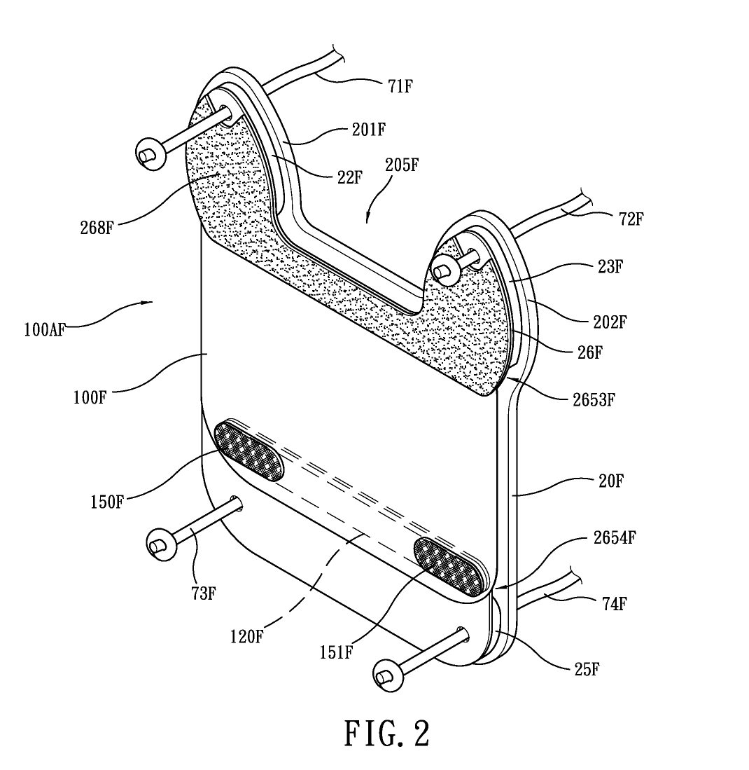

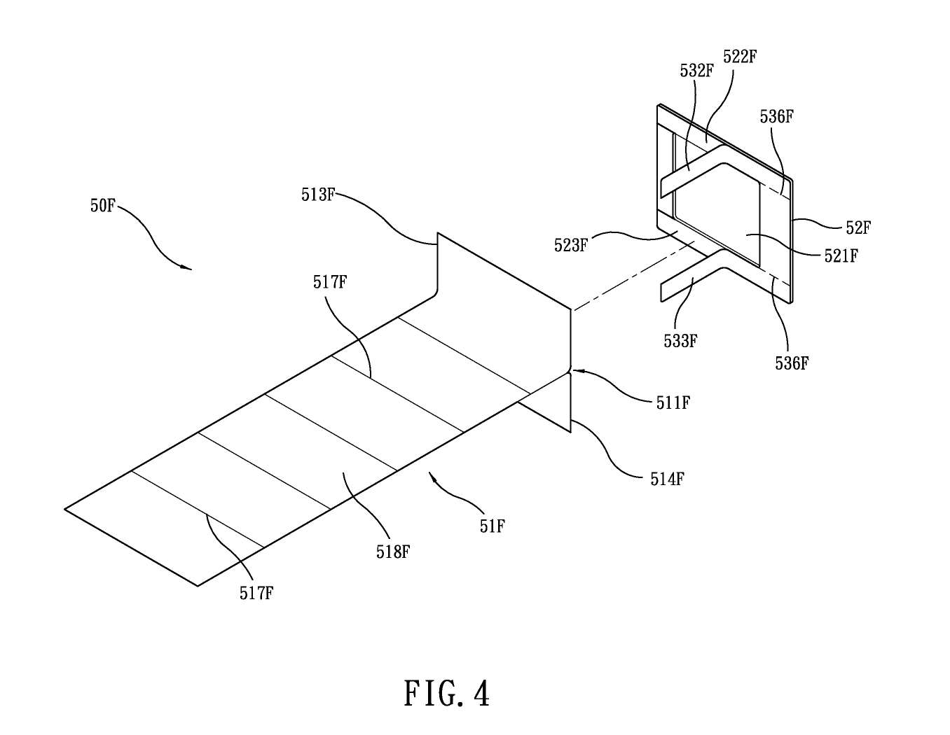

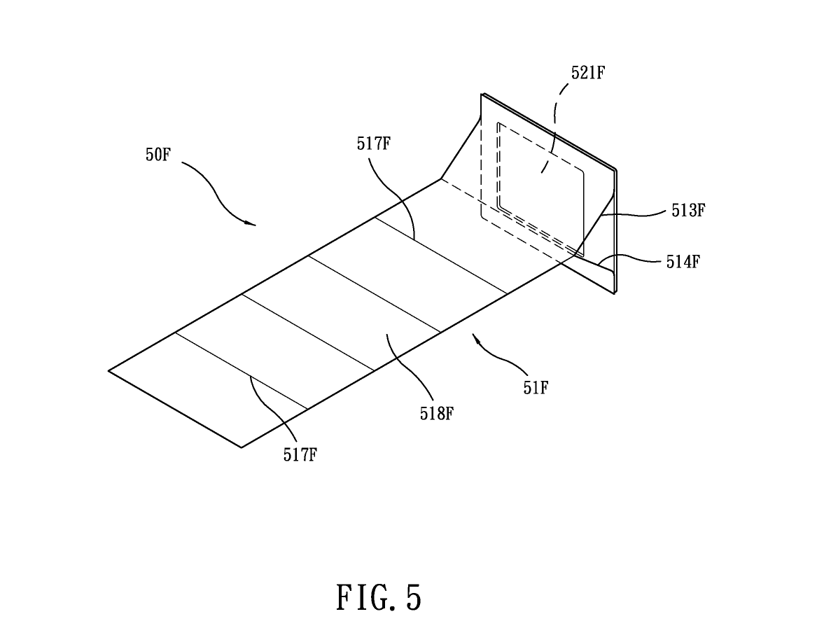

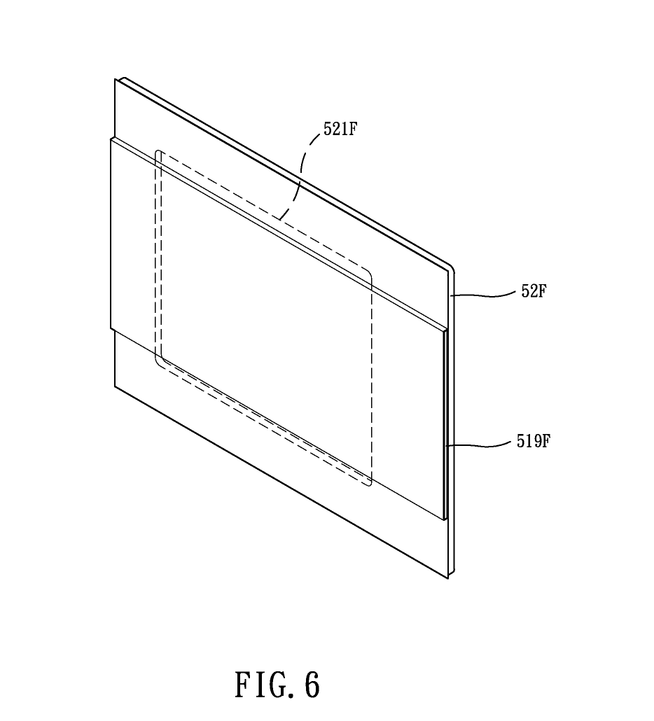

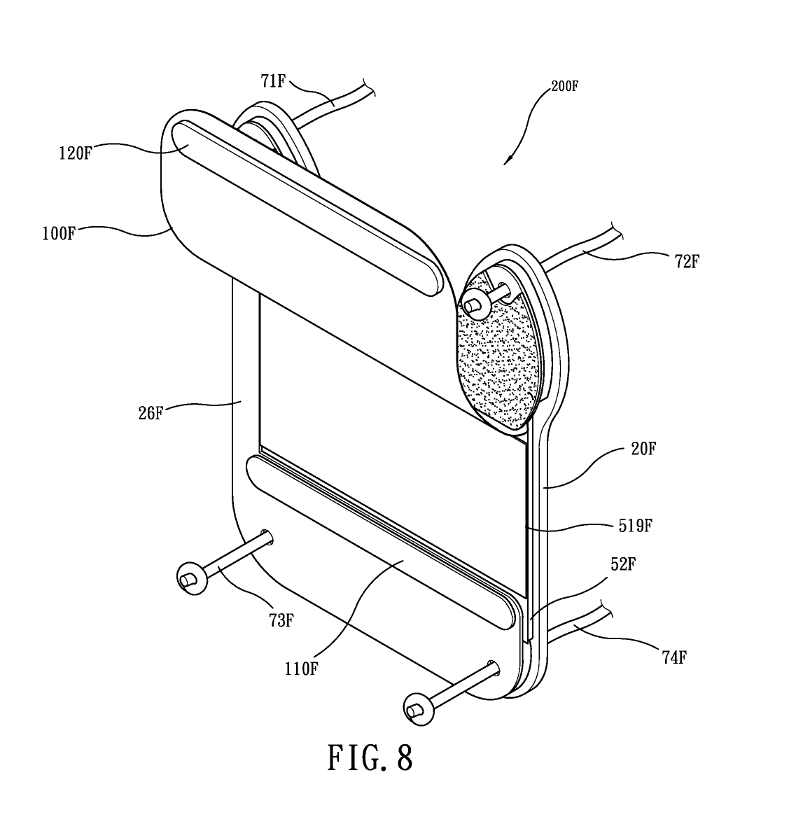

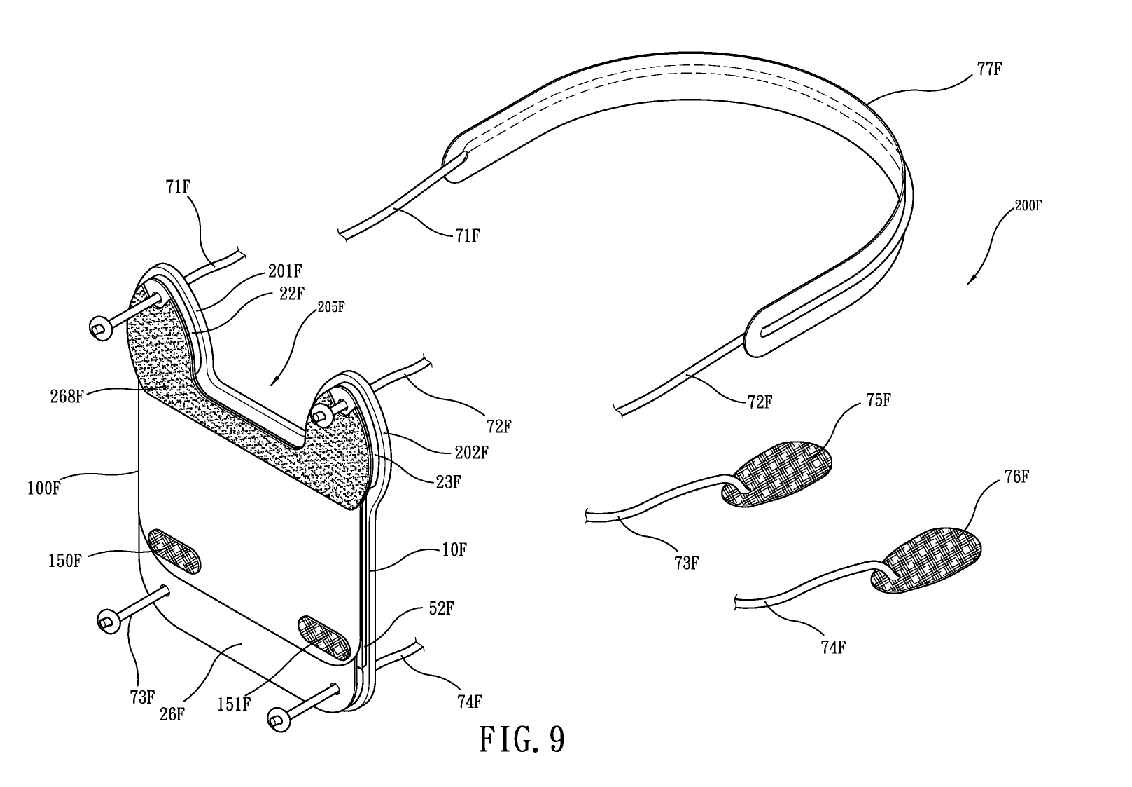

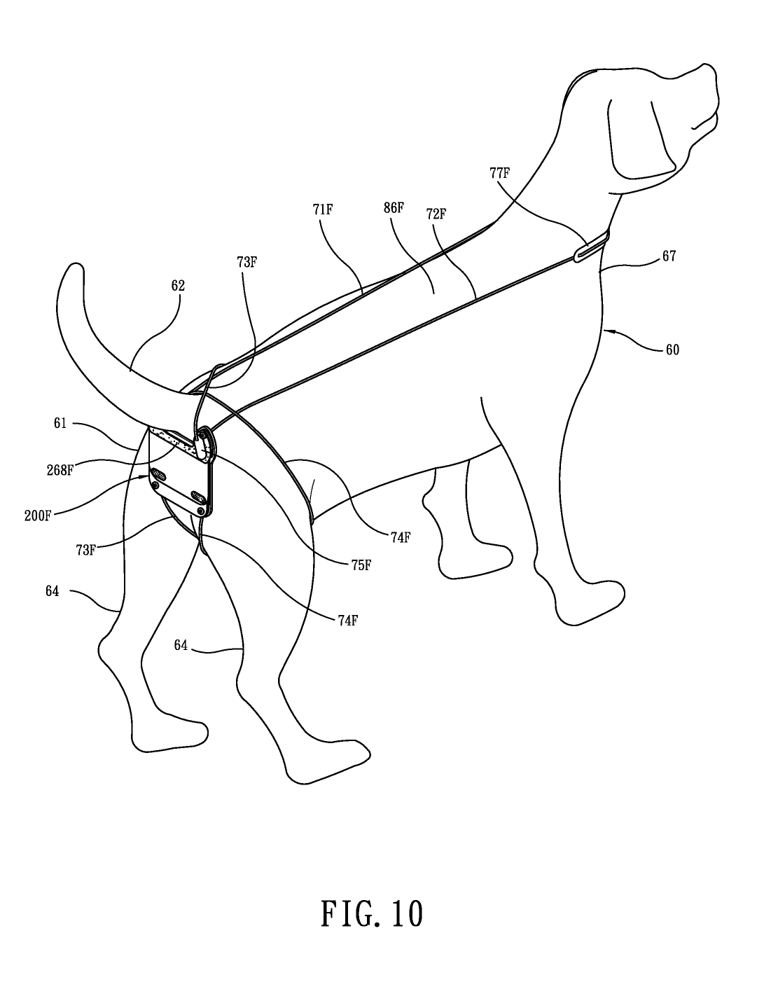

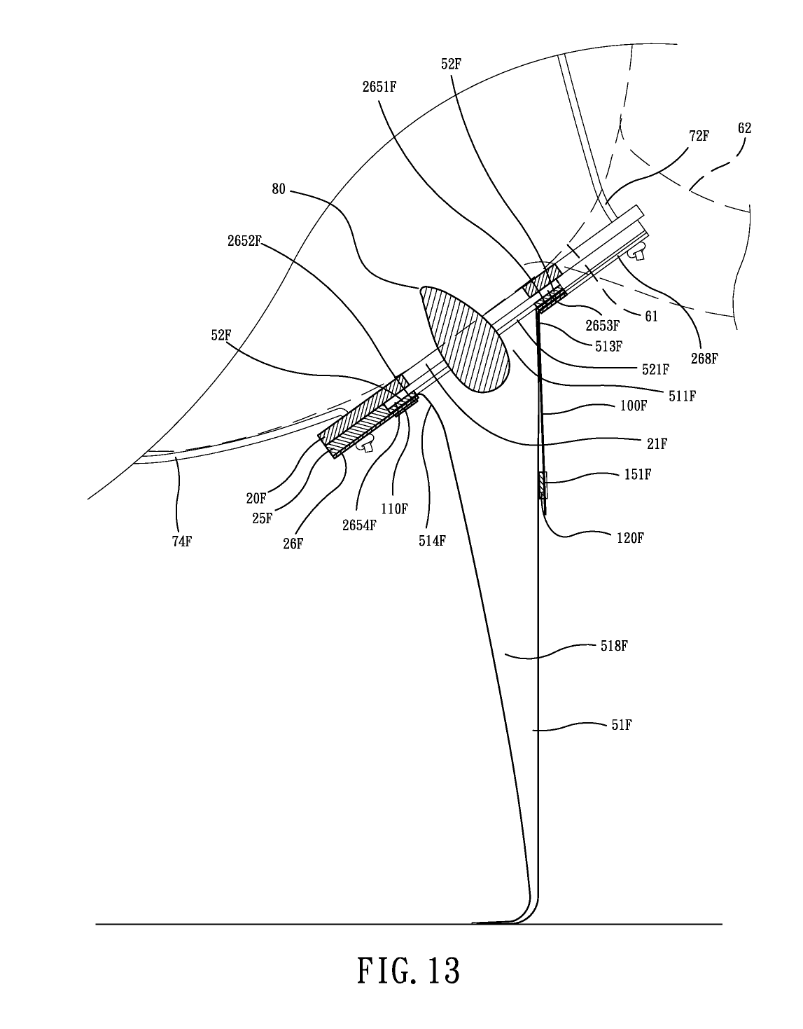

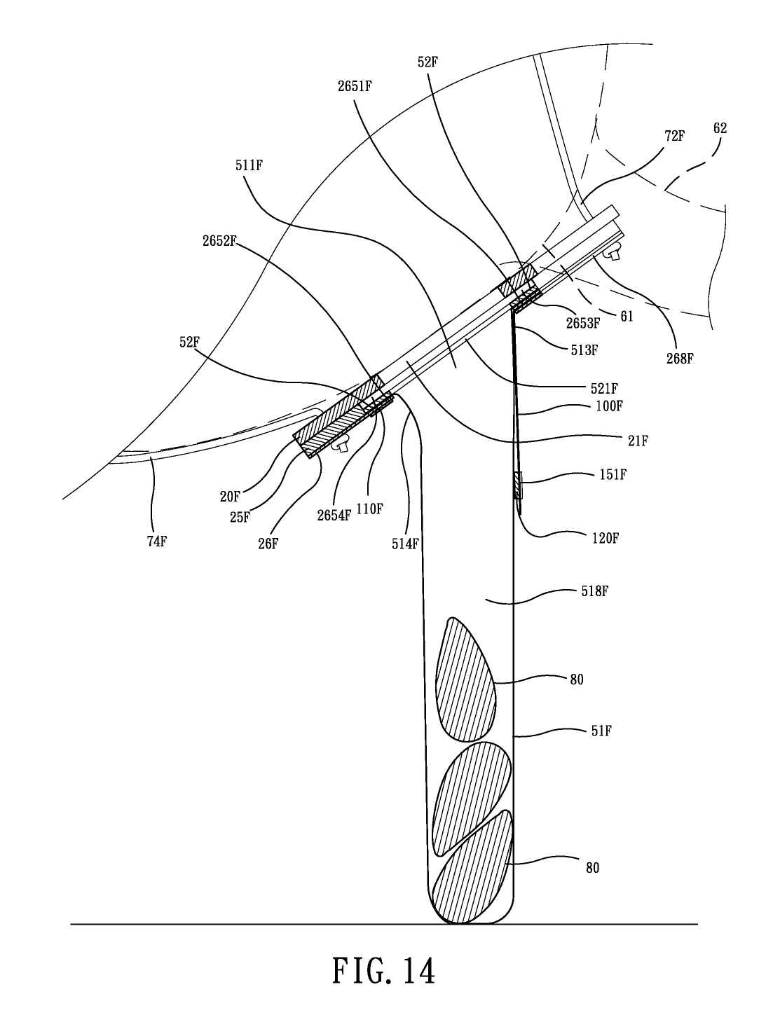

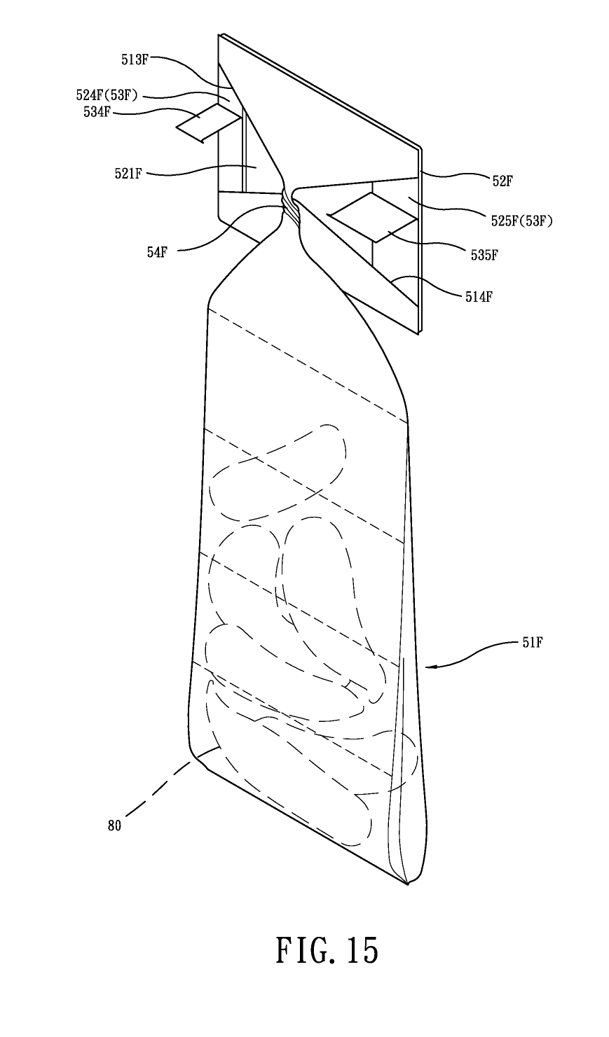

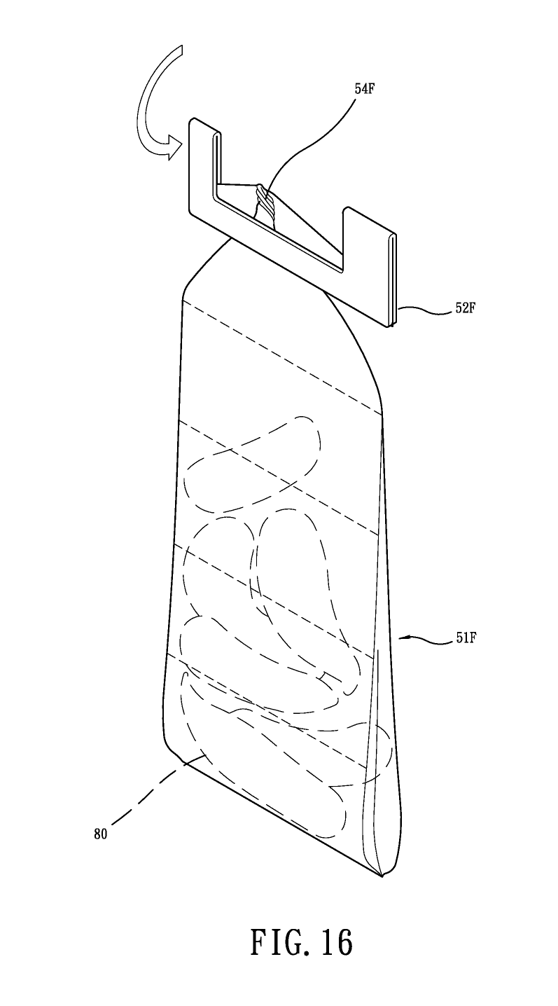

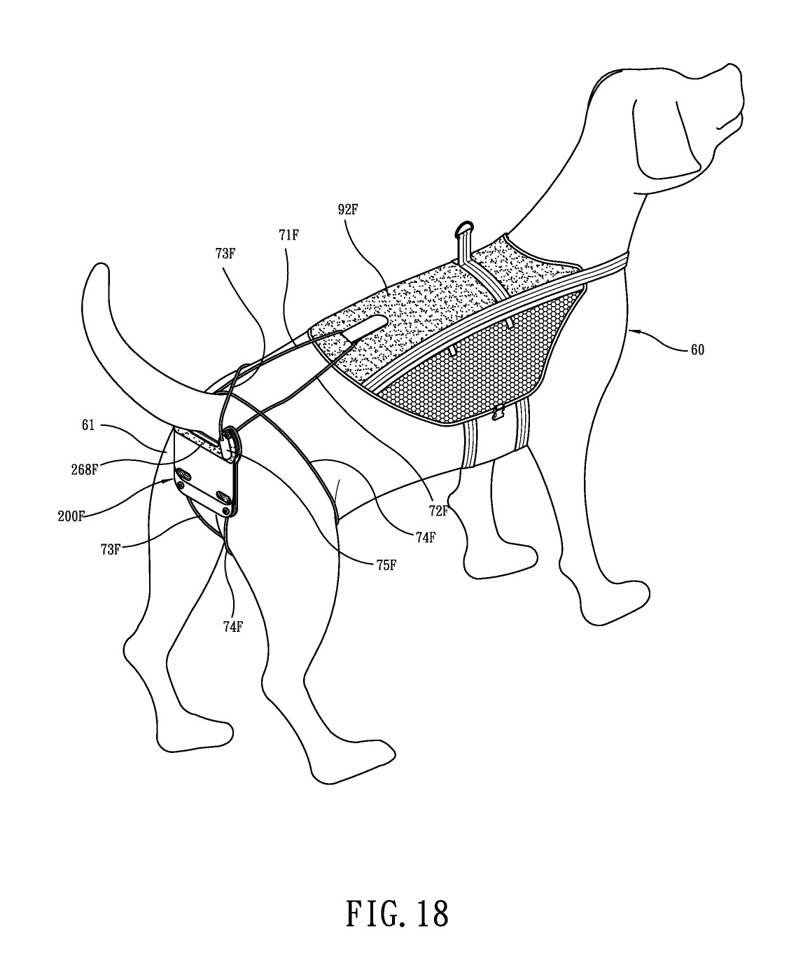

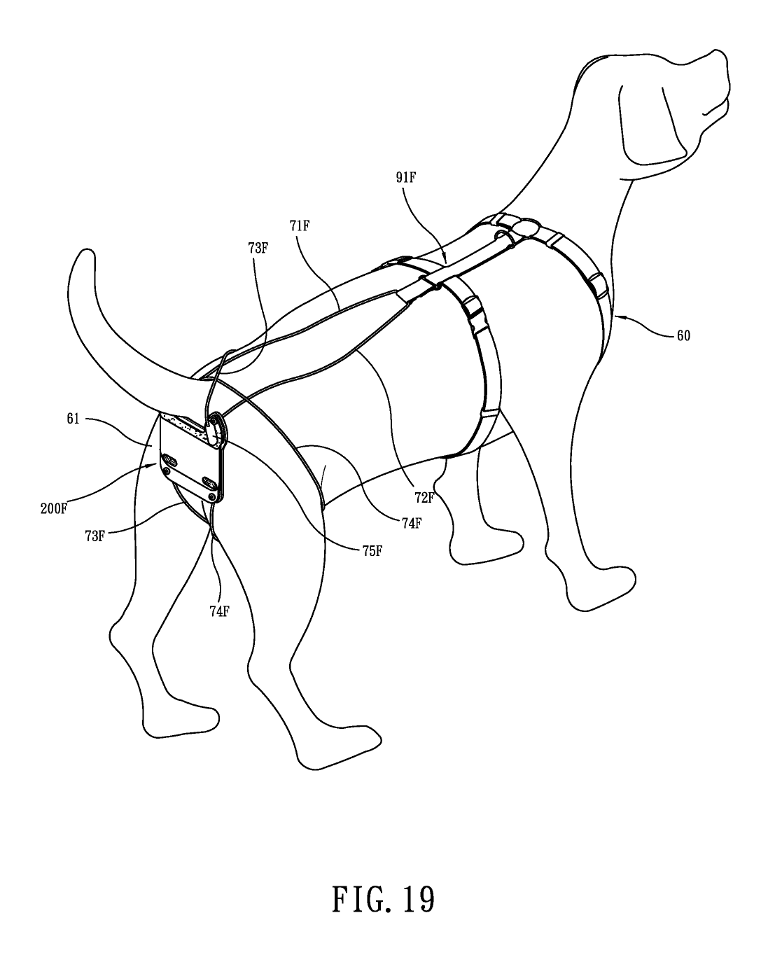

Referring to FIGS. 1 to 19 of the drawings, a dog excrement collector 200F according to a first preferred embodiment of the present invention is illustrated, wherein the dog excrement collector 200F comprises a wearable toilet 100AF and a pouch 50F. As shown in FIGS. 1 and 2, the wearable toilet 100AF comprises a pad body 20F, a retention member 26F, a covering member 100F, one or more gaskets 22F, 23F, 24F, 25F, and one or more carrying belts 71F, 72F, 73F, 74F. The pad body 20F is a soft flat object, which can be made by foam plastics or rubber materials. The pad body 20F has two spaced apart first pad extending portions 201F, 202F integrally and upwardly extended from a top edge of the pad body 20F, wherein a first pad recess 205F is defined between the first pad extending portions 201F, 202F of the pad body 20F. The pad body 20F further has a pad through window 21F adjacent to the first pad recess 205F to communicate the front and rear sides of the pad body 20F. The pad body 20F further has a plurality of pad perforations 206F provided at the first pad extending portion 201F, the second pad extending portion 202F, and the bottom portion 204F of the pad body 20F at two sides thereof respectively. In other words, four pad perforations 206F are preferably formed at the peripheral portion of the pad body 20F. The first gasket 22F, second gasket 23F, third gasket 24F, and fourth gasket 25F are provided, preferably by glue, at the first pad extending portion 201F, the second pad extending portion 202F, the left portion 203F, and the bottom portion 204F of the pad body 20F respectively. Accordingly, the first gasket 22F, second gasket 23F, third gasket 24F, and fourth gasket 25F preferably have the same thickness. The first gasket 22F and the second gasket 23F have first and second gasket perforations 221F, 231F respectively, wherein the first and second gasket perforations 221F, 231F are aligned with the pad perforations 206F at the first pad extending portion 201F and the second pad extending portion 202F respectively when the first gasket 22F and the second gasket 23F are mounted at the first pad extending portion 201F and the second pad extending portion 202F respectively. The fourth gasket 25F has two fourth gasket perforations 251F, 252F at two sides thereof respectively to align with the pad perforations 206F at the bottom portion 204F of the pad body 20F respectively when the fourth gasket 25F is mounted at the bottom portion 204F of the pad body 20F. The first gasket 22F, second gasket 23F, third gasket 24F, and fourth gasket 25F are located at the pad body 20F to encircle around the periphery of the pad through window 21F, so as to define an indention area around the periphery of the pad through window 21F. It is worth mentioning that the first gasket 22F, second gasket 23F, third gasket 24F, and fourth gasket 25F can be integrally extended with each other to form an integrated gasket or can be mounted at the retention member 26F instead of mounted at the pad body 20F. The retention member 26F is made with plastic material having a rigidity higher than the pad body 20F, wherein the retention member 26F has spaced apart first and second retention protruding portions 261F, 262F integrally and upwardly extended from a top edge of the retention member 26F. A retention indentation 267F is defined between the first and second retention protruding portions 261F, 262F. The retention member 26F further comprises a third bonding member 268F mounted to the rear surface of the retention member 26F and extended between the first and second protruding portions 261F, 262F, such that the third bonding member 268 is extended along the top portion of the retention member 26F. The retention member 26F has a retention notch 265F, preferably having a U-shape, formed at the center of the retention member 26F and defined an opening at a right side of the retention member 26F. The left portion 263F of the retention member 26F, which is the left portion of the retention notch 265F, is aligned with the third gasket 24F. The retention member 26F further has a plurality of retention perforations 266F formed at the first and second retention protruding portions 261F, 262F and the bottom portion 264F of the retention member 26F at two sides thereof respectively, wherein the retention perforations 266F are aligned with the pad perforations 206F of the pad body 20F respectively. The sizes of the first and second retention protruding portions 261F, 262F and the member indentation 267F of the retention member 26F are slightly smaller than the sizes of the first and second pad extending portions 201F, 202F and the first pad recess 205F of the pad body 20F respectively. The top and bottom edges of the retention notch 265F are aligned with the top and bottom edges of the pad through window 21F of the pad body 20F, such that the retention notch 265F communicates with the pad through window 21F of the pad body 20F. A first slot 2653F is defined between the top edge of the retention notch 265F of the retention member 26F and the pad body 20F and a second slot 2654F is defined between the bottom edge of the retention notch 265F and the pad body 20F, so as to define a first retention wall 2651F and a second retention wall 2652F corresponding to the first and second slots 2653F, 2654F. The two slots 2653F, 2654F jointly form a junction for a pouch to be inserted (not shown in the figures). Accordingly, the top rim 130F of the covering member 100F is coupled at the first retention wall 2651F, wherein the bottom rim 140F of the covering member 100F serves as a free edge to be freely folded, such that the covering member 100F normally covers the pad through window 21F to hide the bag body 20F and unfolds to expose the bag body 20F by the gravity of the dog's droppings. The coverage area of the covering member 100F is slightly larger than the area of the retention notch 265F, so that the covering member 100F is able to cover the area of the retention notch 265F of the retention member 26F. A second attachment film 120F, preferably a magnetic film, is provided at an inner side of the covering member 100F, wherein the length of the second attachment film 120F is about the same length of the second retaining wall 2652F. A first attachment film 110F, also preferably a magnetic film, is provided at an outer side of the retention member 26F corresponding to the second attachment film 120F. Preferably, the first and second attachment films 110F, 120F are magnetically attracted with each other, such that at least one of the first and second attachment films 110F, 120F is magnet while the other end is made of magnetically attracting material such as metal. Two spaced apart fourth bonding members 150F, 151F are provided at the outer side of the covering member 100F to align with two sides of the second attachment film 120F respectively. Preferably, the fourth bonding members 150F, 151F and the third bonding member 268F are hook-and-loop fasteners, i.e. “Velcro” that can be detachably coupled with each other. The bottom rim 140F of the covering member 100F (the free edge thereof) is held by the detachably attachment between the first and second attachment films 110F, 120F.

When there is no external force, the bottom rim 140F (free end) of the covering member 100F is able to lean against the retention member 26F and cover the retention notch 265F, such that the pouch can be folded in a compact and flat manner (not shown in the figures) in between the pad body 20F and the covering member 100F. The aligned pad perforations 206F, 221F, 231F, 251F, 252F, and 266F of the pad body 20F, the first gasket 22F, second gasket 23F, fourth gasket 25F, and the retention member 26F can be respectively connected via the carrying belts 71F, 72F, 73F, and 74F. Meanwhile the first gasket 22F, second gasket 23F, third gasket 24F, and fourth gasket 25F can also be produced with the pad body 20F by another existing method; that is, the first gasket 22F, second gasket 23F, third gasket 24F, fourth gasket 25F, and the pad body 20F can be formed to have an integrally molding method.

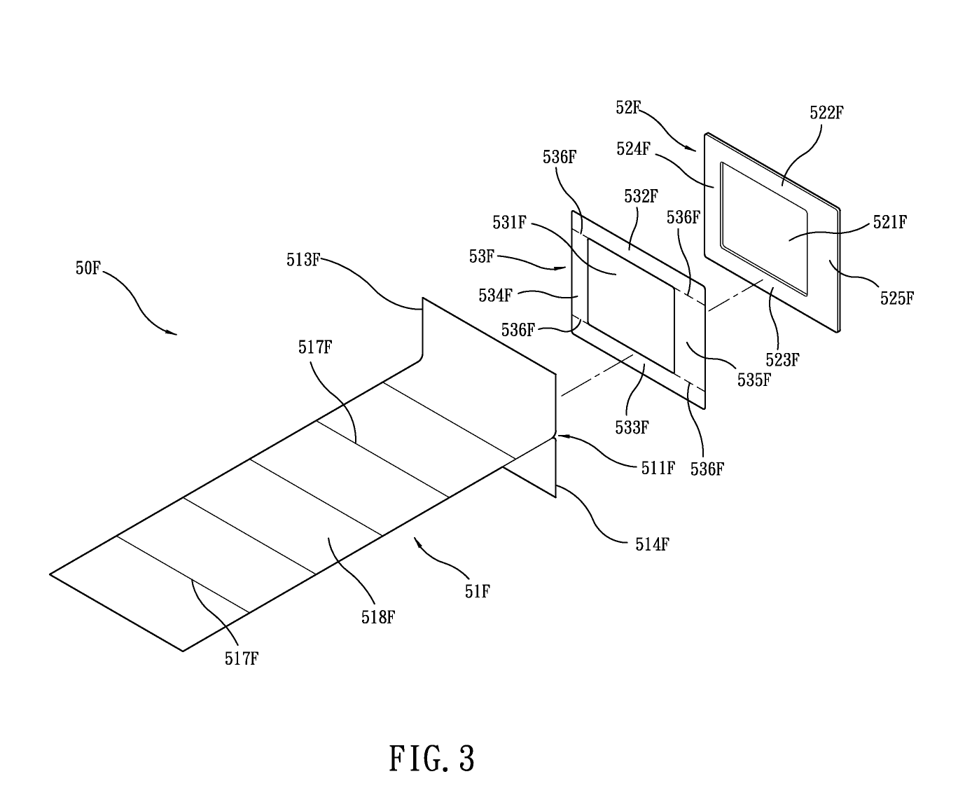

As shown in FIGS. 3 to 6, the pouch 50F according to the preferred embodiment is illustrated. The pouch 50F comprises a pouch retention frame 52F, preferably having a rectangular shape, and an elongated bag body 51F which can be made of plastic, wherein the bag body 51F is coupled to the pouch retention frame 52F. The pouch retention frame 52F can be made with materials of plastic or paper. The pouch retention frame 52F has a pouch through hole 521F at a center portion thereof and defines two sets of opposite peripheral portions encircling the pouch through hole 521F, i.e. a first frame peripheral portion 522F, a second frame peripheral portion 523F, a third frame peripheral portion 524F and a fourth frame peripheral portion 525F. The bag body 51F can be made with regular plastic materials, biodegradable mixed materials, or plastic materials that have been added with calcium carbonate. The bag body 51F is configured to have an elongated structure, wherein the bottom end and peripheral edges of the bag body 51F are sealed so as to contain liquid without leakage. The bag body 51F has a top opening defining an inlet 511F to allow dog droppings to enter into the bag body 51F through the inlet 511F. The bag body 51F comprises an accommodating space 518F that communicates with the inlet 511F. The bag body 51F further has a first pouch extending portion 513F and a second pouch extending portion 514F extended from two opposite edges of the inlet 511F of the bag body 51F, wherein each of the first and second pouch extending portions 513F, 514F has a predetermined length. The first and second pouch extending portions 513F, 514F are affixed to the bottom sides of either of the two opposite first frame peripheral portion 522F and second frame peripheral portion 523F of the pouch retention frame 52F, wherein the first pouch extending portion 513F and the second pouch extending portion 514F may also apply thermocompression or glue to attach to the pouch retention frame 52F. According to the preferred embodiment, glue is pre-applied to the bottom side of the pouch retention frame 52F that serves as an adhering surface of the pouch retention frame 52F, wherein a protection film 53F is detachably provided on the adhering surface of the pouch retention frame 52F to protect the glue thereon. The protection film 53F, having a size and shape corresponding to the pouch retention frame 52F, has a film through hole 531F at a center portion thereof and defines two sets of opposite peripheral portions encircling the film through hole 531F, i.e. a first film side 532F, a second film side 533F, a third film side 534F and a fourth film side 535F. A fracture line 536F is provided at each connection of the first film side 532F, the second film side 533F, the third film side 534F and the fourth film side 535F, such that the first film side 532F, the second film side 533F, the third film side 534F and the fourth film side 535F can be selectively removed from the first frame peripheral portion 522F, the second frame peripheral portion 523F, the third frame peripheral portion 524F and the fourth frame peripheral portion 525F respectively. Accordingly, the first film side 532F and the second film side 533F are removed from the first frame peripheral portion 522F and the second frame peripheral portion 523F, such that the first and second pouch extending portions 513F, 514F of the bag body 51F are affixed to the first film side 532F and the second film side 533F, so as to affix the bag body 51F to the pouch retention frame 52F. It is worth mentioning that the first and second pouch extending portions 513F, 514F of the bag body 51F can be affixed to either one set of opposite peripheral portions of the pouch retention frame 52F. The glue can be applied to the first and second pouch extending portions 513F, 514F of the bag body 51F while no glue will be applied at the pouch retention frame 52F. Furthermore, a plurality of folding lines 517F are spacedly provided at the bag body 51F, such that the bag body 51F can be overlappedly and evenly folded between the top opening and the bottom edge to reduce the overall size for fitting to the wearable toilet 100AF.

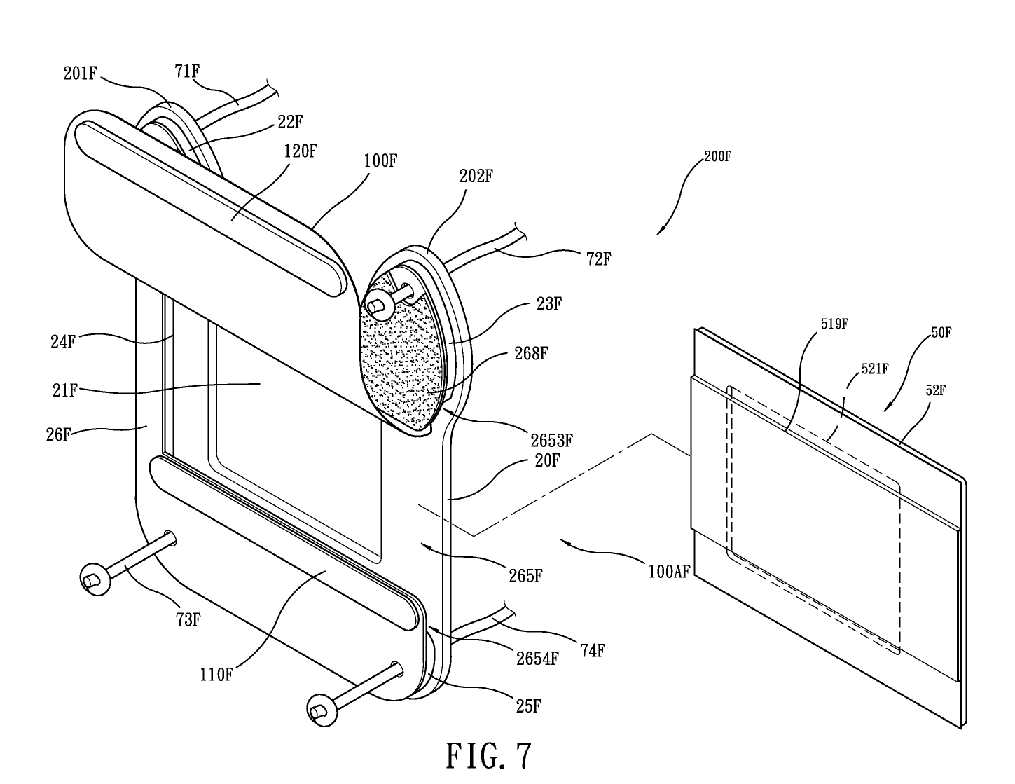

As shown in FIGS. 7 to 14, the dog excrement collector 200F of the present invention comprises the above mentioned wearable toilet 100AF and a pouch 50F. The following is going to describe the method of assembling, method of using, and effects produced of the dog excrement collector 200F. The bag body 51F of the pouch 50F can be overlappedly folded along the folding lines 517F which are extended between the first peripheral edge 522F and the second peripheral edge 523F of the bag body 51F, wherein the folding lines 517F form a plurality of even folding sections to be overlappedly folded. In particular, a width of the folded bag body 51F is smaller than a width of the pouch through hole 521F of the pouch retention frame 52F.

The bottom rim 140F of the covering member 100F is upwardly lifted or folded to help the end of the two opposite first frame peripheral portion 522F and second frame peripheral portion 523F of the pouch retention frame 52F to insert from the right side of the slots 2653F and 2654F formed in the between of the retention member 26F and the pad body 20F and to stop by the blocking of the inner margin of the third gasket 24F. The folded bag body 51F is within the retention notch 265F, and the pouch through hole 521F of the pouch retention frame 52F aligns with and connects to the pad through window 21F of the pad body 20F. Meanwhile, the inlet 511F of the bag body 51F slightly closes itself as the bag body 51F is folded. As the pouch 50F has been set ready in the wearable toilet 100AF, the covering member 100F is then covered to the original position thereof, so as to cover the folded bag body 51F and restrict it in between the pad body 20F and the covering member 100F. The second attachment film 120F again couples the first attachment film 110F, preferably by magnetically attraction, so as to let the bag body 51F of the pouch 50F stay in between the pad body 20F and the covering member 100F without falling out when there is no external force applied thereto.

The dog excrement collector 200F can be directly worn on the dog 60, as an example, with the carrying belts 71F, 72F, 73F, and 74F, which lets the inner side of the wearable toilet 100AF to lean on the butt 61 of the dog 60, and the bottom rim of the first pad recess 205F of the pad body 20F allows the root 63 of the dog's tail 62 to rest on, wherein the carrying belts 71F and 72F toggle on the dog's neck 67 together and protect the dog's neck 67 with a neck collar 77F, while the ends of the carrying belts 73F and 74F respectively have a first coupling member 75F and a second coupling member 76F. The carrying belts 73F and 74F pass through the groin 65 between the two hinds 64 of the dog, then across on the dog's back 66, and respectively affixedly attach to the third bonding member 268F on the external side of the retention member 26F, wherein the first coupling member 75F and the second coupling member 76F, and the third bonding portion 268F are Velcro that can detachably couple with each other. The carrying belts 71F, 72F, 73F, and 74F are preferably flexible elastic belts. By using these flexibly elastic carrying belts 71F, 72F, 73F, and 74F, the dog excrement collector 200F is worn on the dog 60, while the pad through window 21F of the pad body 20F can still constantly align to the anus of the dog 60 in an approximately upright manner.

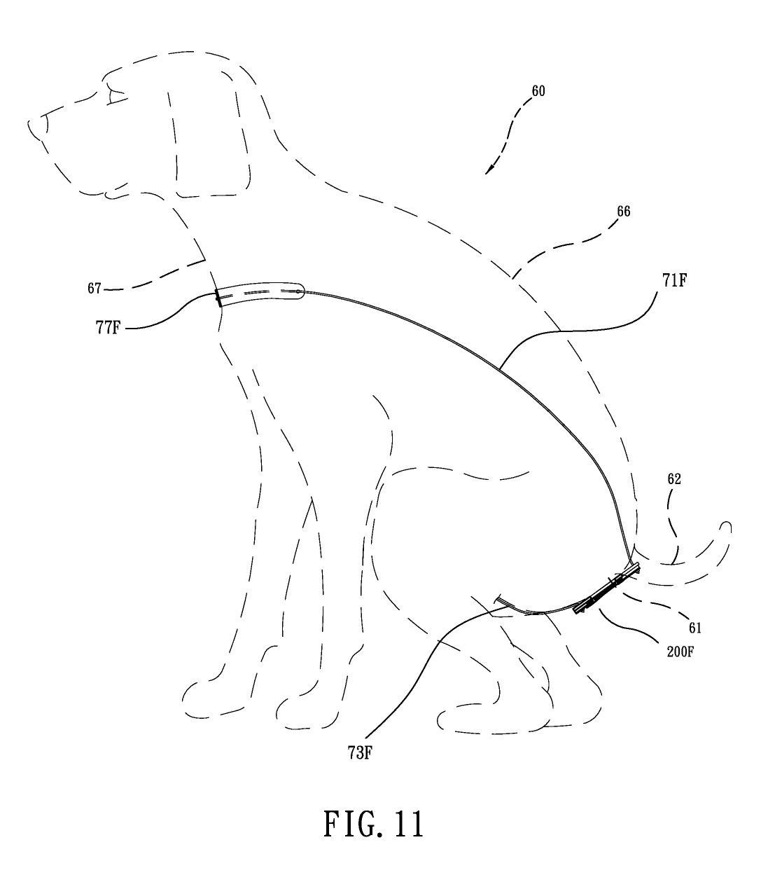

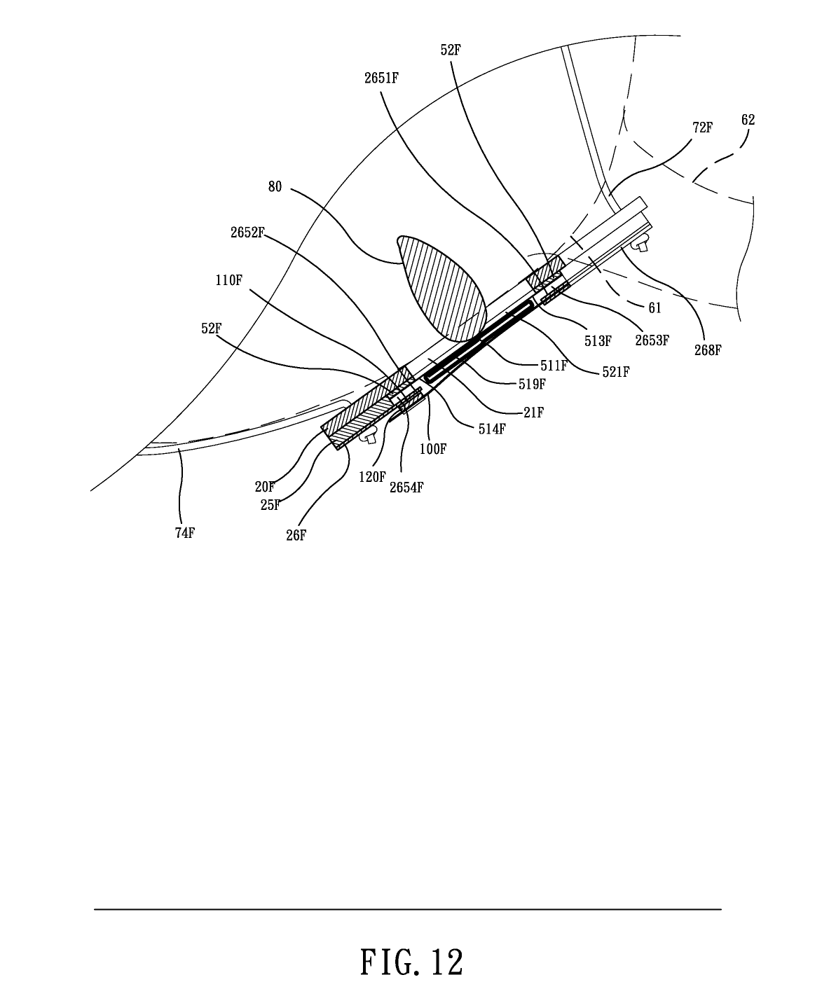

Referring to FIGS. 11 to 14, when a dog 60 is about to defecate, the dog, as an usual action of a dog 60, arches its back 66 for further push, and its butt 61 will also turn to face the ground in an angle. Meanwhile, the pad body 20F will be shifted via the dog's butt 61 to face the ground in an angle with the carrying belts 71F and 72F, such that the pad through window 21F of the pad body 20F can constantly align to the anus of the dog 60 without shifting. At normal condition when there is no external force applied to the covering member 100F, the second attachment film 120F couples with the first attachment film 110F, preferably by magnetically attraction, to retain the bag body 51F of the pouch 50F between the pad body 20F and the covering member 100F without falling out. As the dog dropping 80 goes out, it instantly passes the pad through window 21F of the pad body 20F, and the pouch through hole 521F of the pouch retention frame 52F, and immediately pushes toward the folded bag body 51F and simultaneously pushes to the covering member 100F by gravity. Because the gravity force of the dog dropping 80 is greater than the engagement between the first attachment film 110F and the second attachment film 120F, the bottom rim 140 of the covering member 100F will outwardly open and hang downwardly. The bag body 51F will naturally deploy down to a strip based on the gravity. The inlet 511F of the bag body 51F will be opened by the dog dropping 80, so as to allow the continuously receive the dog droppings 80 to drop into the accommodating space 518F of the bag body 51F. Since the first frame peripheral portion 522F and the second frame peripheral portion 523F of the pouch retention frame 52F are blocked by the retaining walls 2651F and 2652F of the retention member 26F, the entire pouch 50F will be suspendedly hung without detaching from the pouch retention frame 52F. When the dog 60 completely finishes defecating, the pouch 50F can then be taken out from the right side and the second attachment film 120F of the covering member 100F will re-couple to the first attachment film 110F again. A dog owner can twist the bag body 51F at the place thereof below the pouch retention frame 52F for a few rounds, so as to form a tightening portion 54F that closes the inlet 511F of the bag 51F to prevent the smell of the dog dropping 80 from diffusing. Then, the third film side 534F and fourth film side 535F of the protection film 53F can be removed from the other set of two opposite third frame peripheral portion 524F and fourth frame peripheral portion 525F of the pouch retention frame 52F. The pouch retention frame 52F can be downwardly folded to clip at the tightening portion 54F of the bag 51F preferably by adhering so as to prevent the tightening portion 54F of the bag 51F from loosening again. In this way, the sealed pouch 50F can be discarded in a garbage can designated for collecting dog dropping 80.

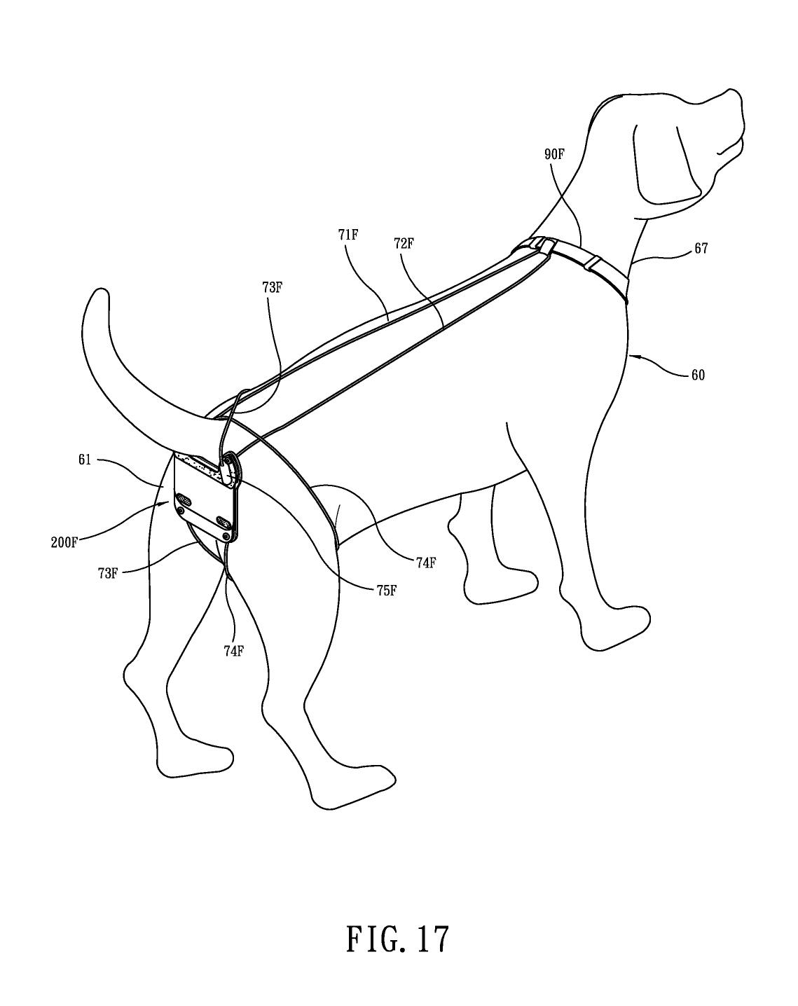

FIGS. 17 to 19 illustrates an alternative method to wear the wearable toilet 100AF, wherein the carrying belt 71F and carrying belt 72F of the wearable toilet 100AF may not only directly toggle on the dog's neck 67. Accordingly, the carrying belt 71F, 72F can connect to objects, such as the collar 90F, harness 91F, and dog clothes 92F, that are worn on the dog, so as to provide the dog excrement collector 200F of the present invention multiple usage modes.

The above is a first preferred embodiment of the dog excrement collector 200F of the present invention. The following further focuses on a second preferred embodiment of the dog excrement collector 200 as an alternative mode of the first embodiment. The dog excrement collector 200 of the present embodiment comprises a wearable toilet 100, a fixing member 40, and a pouch 50.

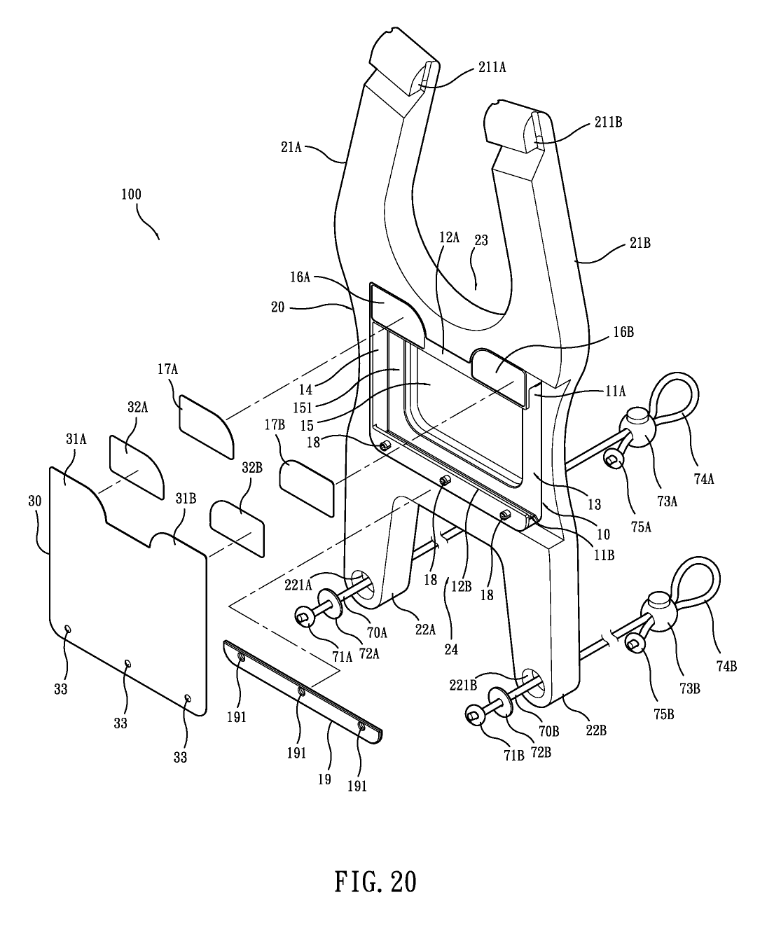

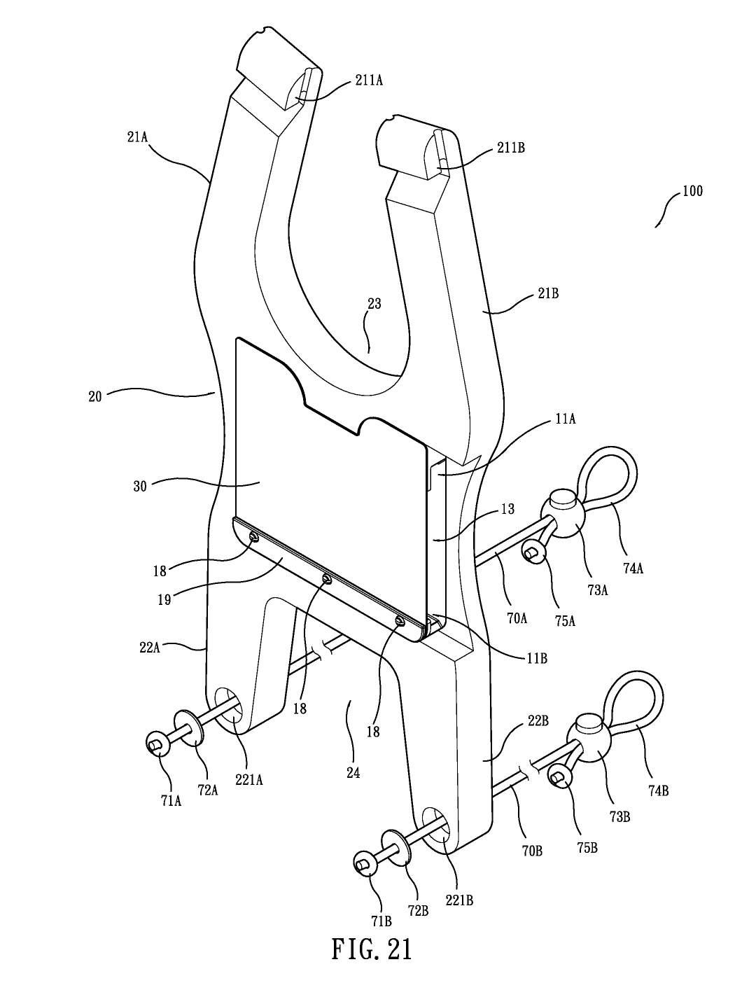

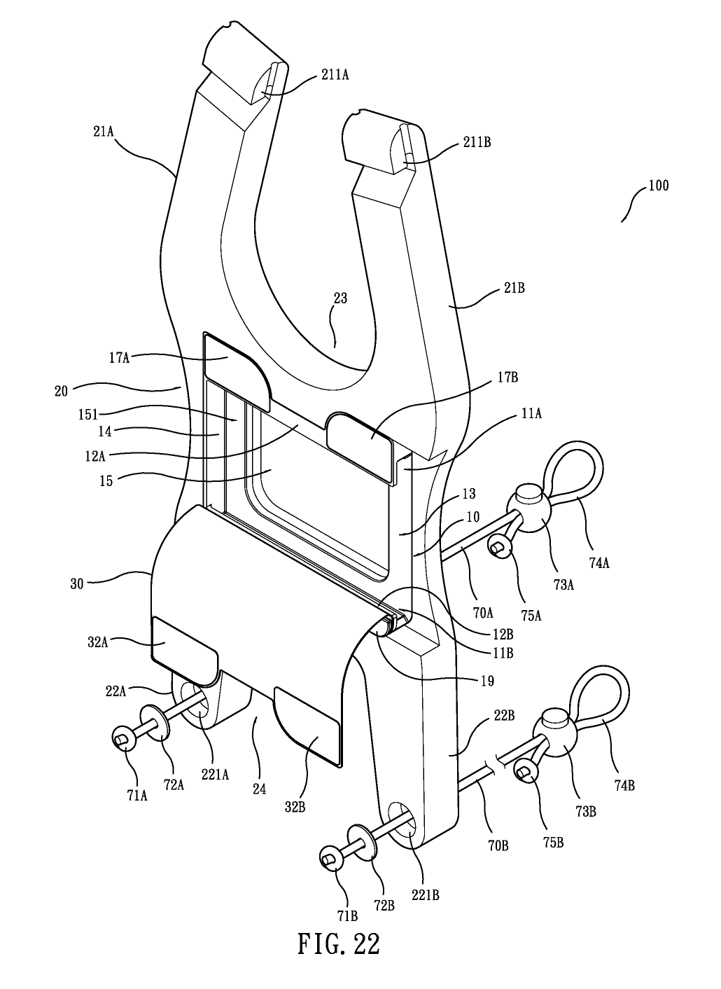

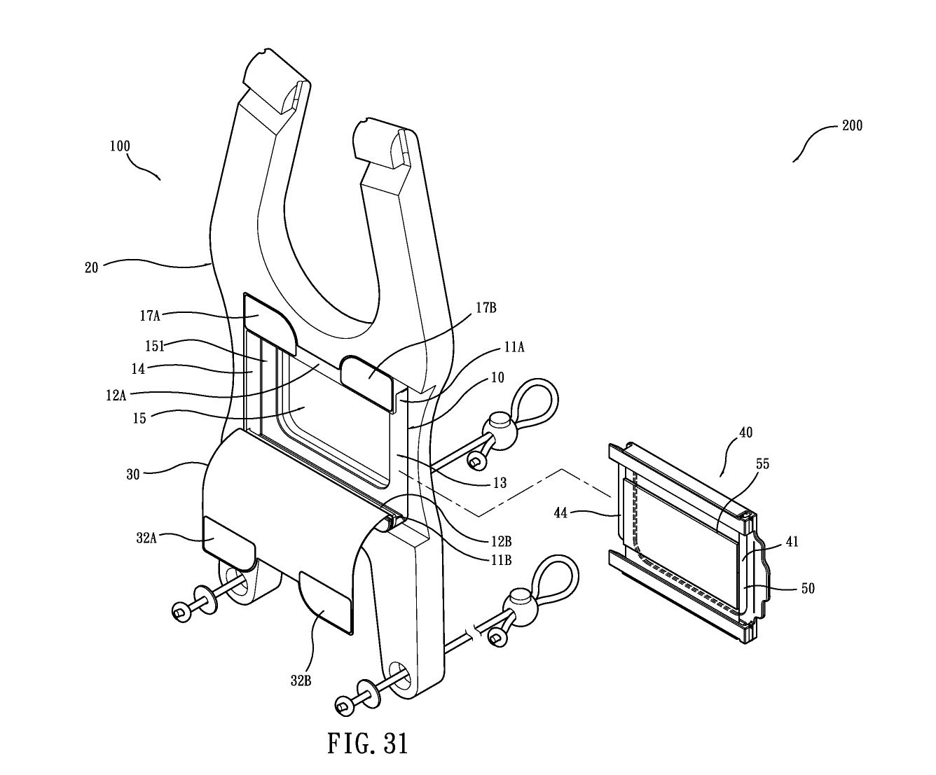

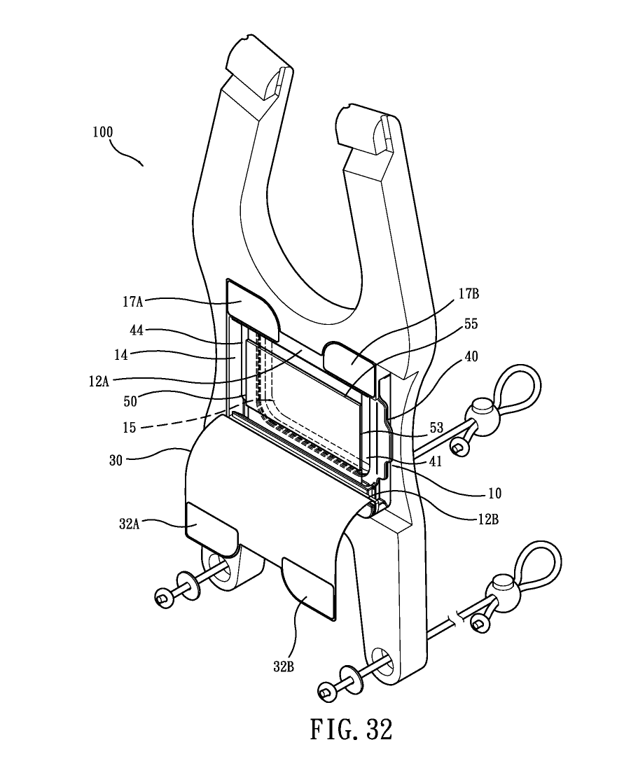

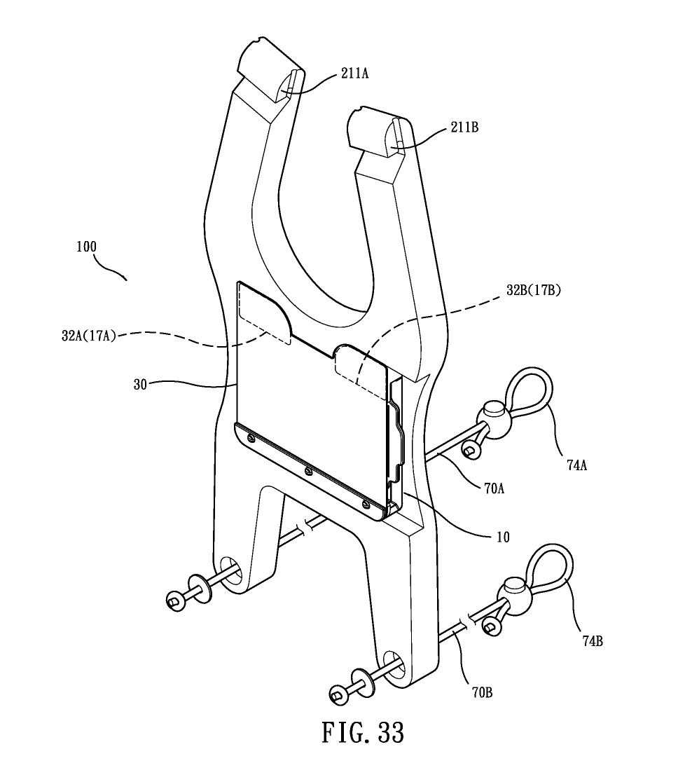

As shown in FIGS. 20 to 22, the wearable toilet 100 comprises a junction member 10, a pad body 20, a covering member 30, and one or more carrying belts 70A and 70B. The pad body 20 is made with soft materials of plastics or rubber, and is configured to have a flat plane structure, wherein the junction member 10 is provided at the center of the pad body 20. In particular, the pad body 20 enclosedly covers the bottom side and periphery of the junction member 10. The pad body 20 and junction member 10 both have a through hole 15 that connect to each other. The pad body 20 has two spaced apart first pad extending portions 21A, 21B integrally and upwardly extended from a top edge of the pad body 20, wherein a first pad recess 23 is defined between the first pad extending portions 21A, 21B of the pad body 20. The pad body 20 further has two spaced apart second pad extending portions 22A, 22B integrally and downwardly extended from a bottom edge of the pad body 20, wherein a second pad recess 24 is defined between the second pad extending portions 22A, 22B of the pad body 20. Each of the first connecting portions 21A, 21B and the second connecting portions 22A, 22B are bendable to deform the shapes thereof by external forces. Two barb blocks 211A, 211B are formed at the first connecting portions 21A, 21B respectively for the carrying belts 70B, 70A engaging with the barb blocks 211A, 211B. In particular, the loop ends 74A, 74B of the carrying belts 70A, 70B are detachably engaged with the barb blocks 211A, 211B respectively after the carrying belts 70A, 70B are extended across the dog's back. Each of the loop ends 74A, 74B is formed at the carrying belt 70A, 70B corresponding with a cord lock 73A, 73B, wherein each end of the carrying belt 70A, 70B is tightened to form a second knot 75A, 75B. Each of the second pad extending portions 22A, 22B forms an engaging slot 221A, 221B thereat, wherein the engaging slots 221A, 221B are respectively for the carrying belts 70A, 70B to engage with the first knots 71A, 71B at the other ends of the carrying belts 70A, 70B, so as to engage the ends of the carrying belts 70A, 70B at the second pad extending portions 22A, 22B. A washer 72A, 72B is provided at each of the carrying belts 70A, 70B to retain at the first knot 71A, 71B in order to couple at the corresponding second pad extending portion 22A, 22B. The junction member 10 has an indention cavity 151 at the periphery of the through hole 15, wherein a side opening 13 is formed at a side of the indention cavity 151 with respect to the border of the pad body 20, while another side of the indention cavity 151 does not communicate through the border of the pad body 20. A blocking wall 14 is formed at the opposite side of the indention cavity 151 to the side opening 13. Two grooves 11A, 11B are formed at the upper and lower sides of the indention cavity 151 respectively, wherein the fixing member 40 and pouch 50 are together detachably coupled at the grooves 11A, 11B at the same time (as shown in FIG. 31). The junction member 10 has two retention walls 12A, 12B at two external sides corresponding to the grooves 11A, 11B. The retaining wall 12B at the lower side of the junction member 10 has a plurality of spaced apart protruding columns 18. The covering member 30 is a soft sheet that can be flipped. The bottom rim of the covering member 30 has a plurality of covering perforations 33 arranged to engage with the protruding columns 18 respectively. An elongated securing member 19, having a plurality of securing perforations 191, secured on the covering member 30 at a position that the protruding columns 18 are engaged with the securing perforations 191 through the covering perforations 33 so as to sandwich the bottom rim of the covering member 30 between the junction member 10 and the securing member 19. The top rim of the covering member 30 then becomes a free edge to be flipped for opening. The covering member 30 further has two second extending portions 31A, 31B spacedly and upwardly extended from the top edge of the covering member 30, wherein two second attachment films 32A, 32B, preferably two second magnetic films, are provided at the second extending portions 31A, 31B respectively. The junction member 10 further has two first extending portions 16A, 16B spacedly and upwardly extended from the top edge of the junction member 10, wherein two first attachment films 17A, 17B, preferably two first magnetic films, are provided at the first extending portions 16A, 16B respectively. The top rim (free end) of the covering member 30 is detachably coupled to the junction member 10 by the engagement between the first attachment films 17A, 17B and the second attachment films 32A, 32B, preferably by magnetically engagement. When there is no external force, the top rim (free end) of the covering member 30 is arranged to cover the upper edge of the junction member 10 and cover the indention cavity 151, so as to retain the folded bag body 55 (refer to FIGS. 32 and 33) in between the junction member 10 and the covering member 30.

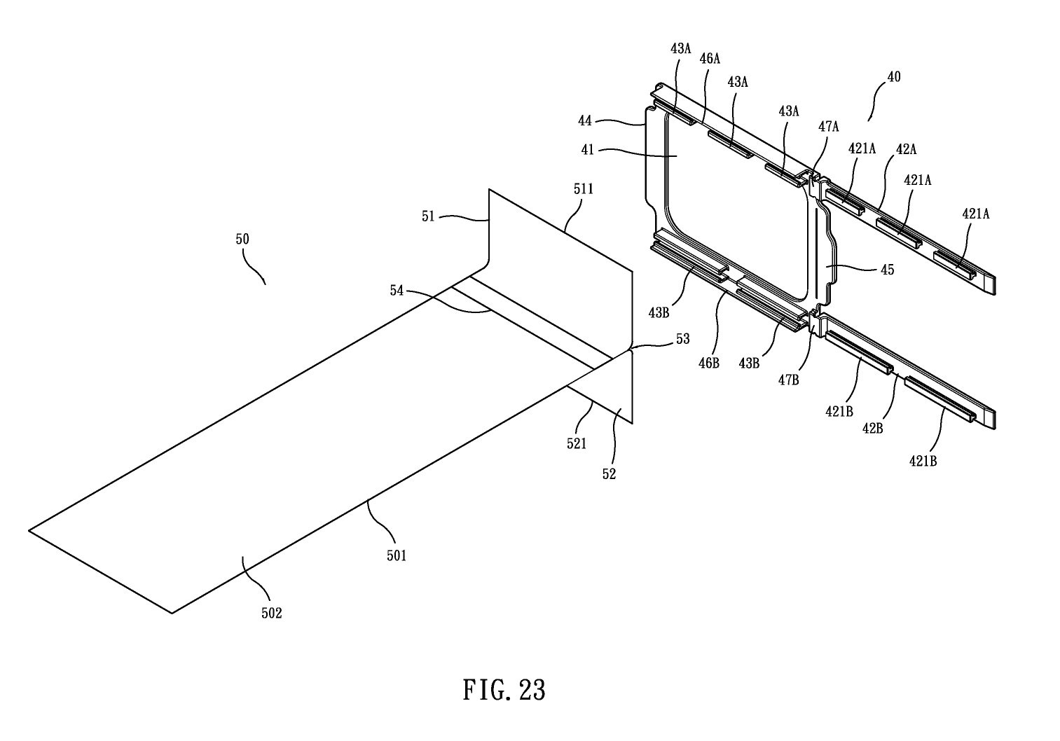

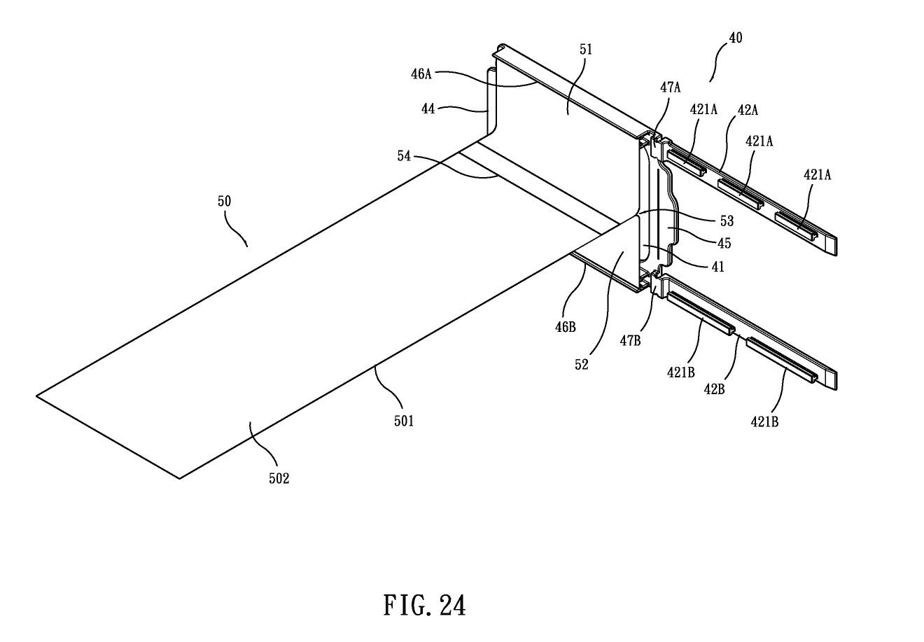

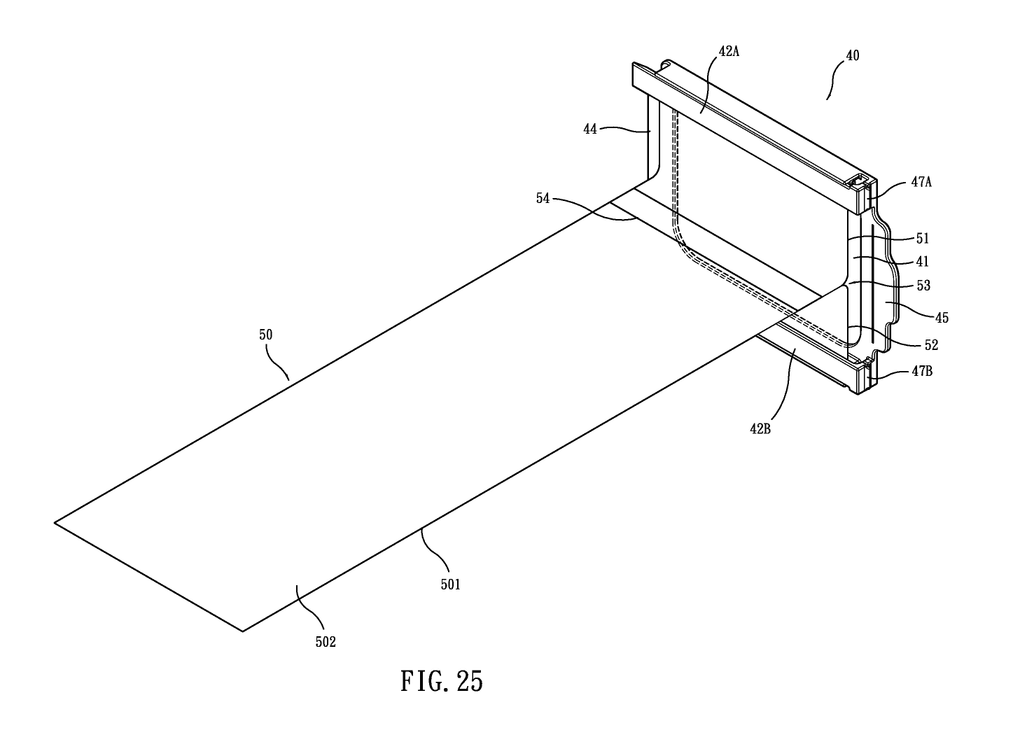

FIGS. 23 to 25 illustrate the pouch 50 of the preferred embodiment. The pouch 50 comprises an elongated plastic bag body 501. The bag body 501 can be made with regular plastic materials, biodegradable blended materials, or plastic materials that have been added with calcium carbonate. The bottom edge and two side edges of the bag body 501 are sealed for preventing any liquid leakage, wherein the top opening of the bag body 501 defines an inlet 53 to allow dog droppings to enter into the bag body 501 through the inlet 53. The bag body 501 has an accommodating space 502 that communicates with the inlet 53. The bag body 501 further has a first extending portion 51 and a second extending portion 52 extended from two sides of the inlet 53, wherein the first extending portion 51 and the second extending portion 52 have a predetermined length. A self-adhesive tape 54 is provided at one of the external sides of the bag body 501, wherein an adhesive layer 541 is provided at the bag body 501 corresponding to the self-adhesive tape 54.

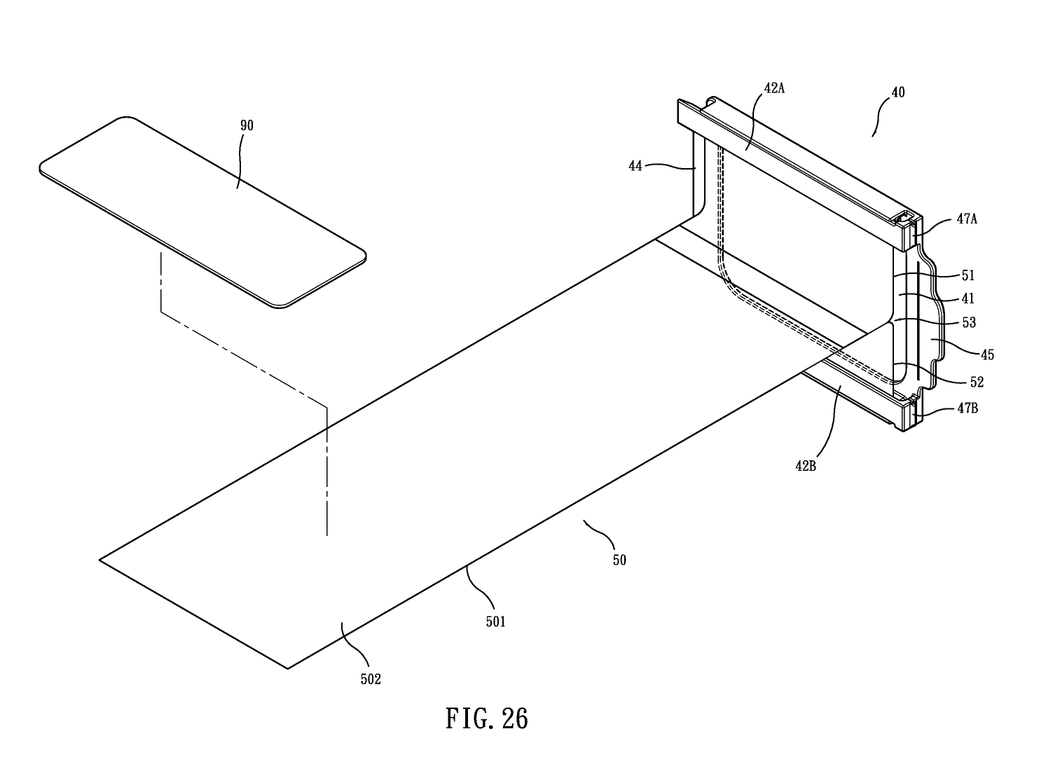

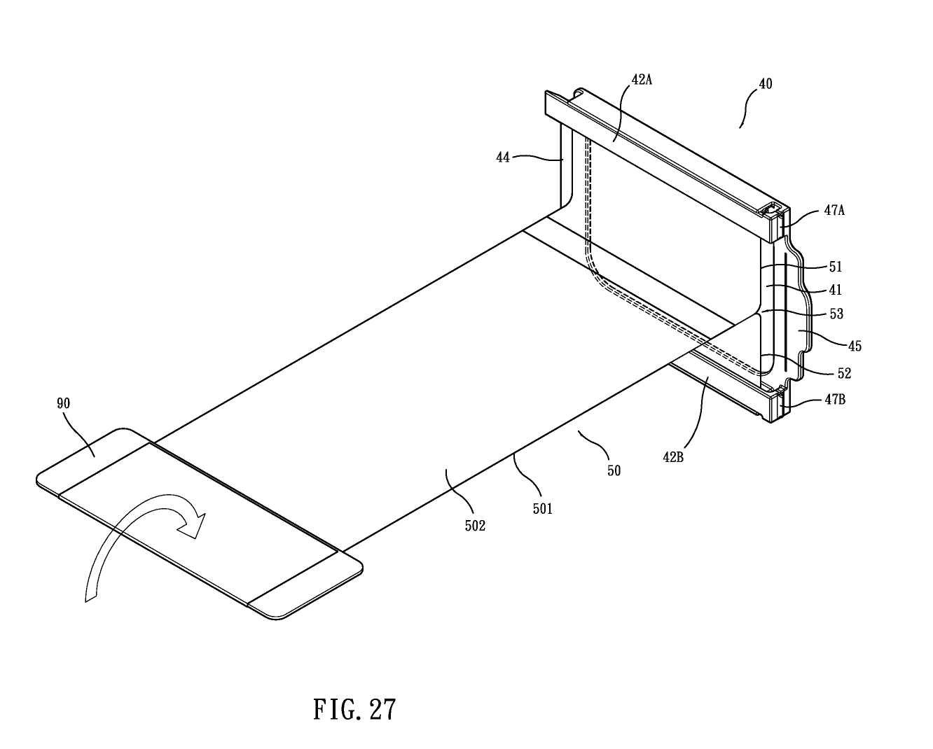

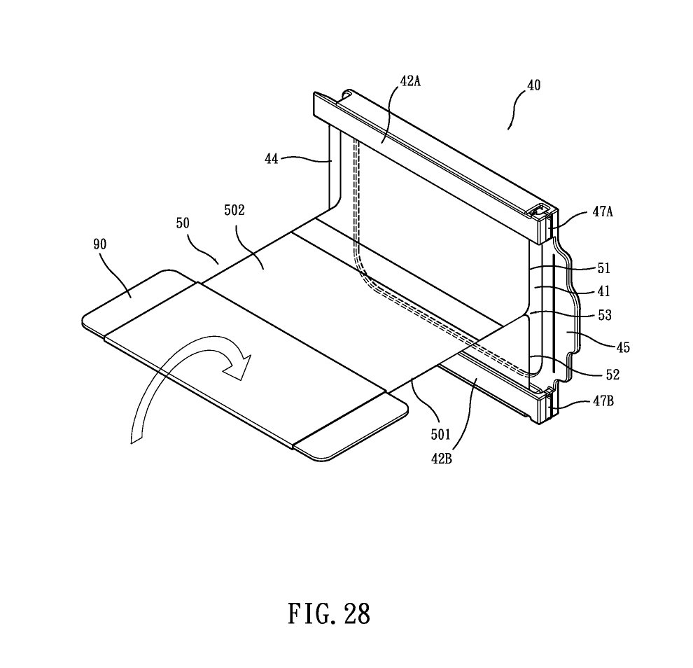

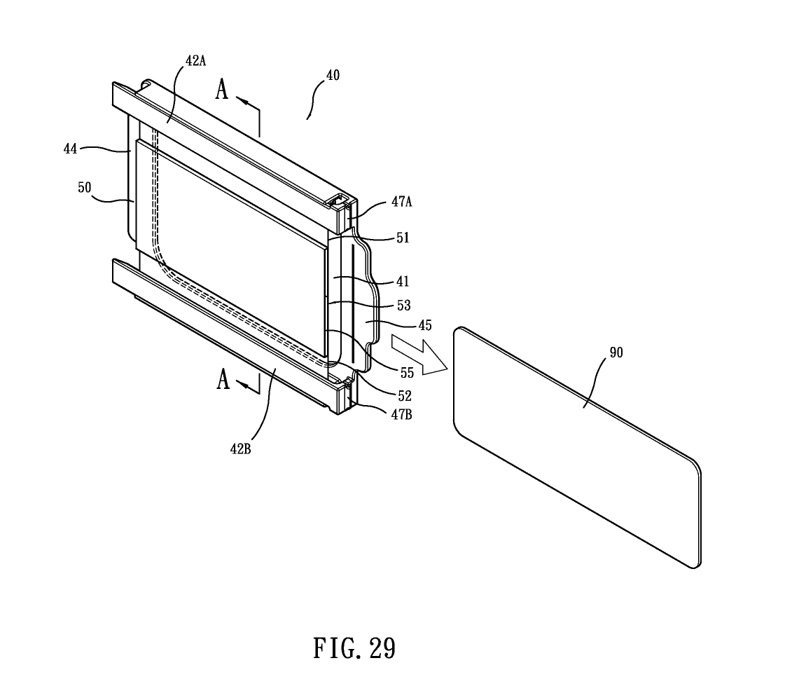

FIGS. 23 to 30 illustrate the fixing member 40. The fixing member 40 is configured to have a sheet-like structure which has a rigidity higher than the covering member 30. Preferably, the fixing member 40 is made by plastic. The fixing member 40 has a center through window 41 and a plurality of embedding grooves 43A, 43B formed at the upper and lower margins of the fixing member 40 at the center through window 41. The inserting end of each of the embedding grooves 43A, 43B forms a neck portion 431A, 431B with reduced diameter. Each of the embedding grooves 43A, 43B forms an embedding gap 432A, 432B internally, wherein each of the embedding grooves 43A, 43B of the same side concertedly forms slightly protruding flanges 46A or 46B at the external sides. The two flanges 46A, 46B can provide the upper edges 511, 521 of the first extending portion 51 and the second extending portion 52 of the pouch 50 to lean on and align with. A side of the center through window 41 forms a stopping edge 44, while another side forms a handheld portion 45 raised in a slight angle, wherein the upper and lower end at one side of the fixing member 40 concertedly extend outward as two pressing buckles 42A and 42B. Each of the pressing buckles 42A, 42B forms a folding portion 47A, 47B between the fixing member 40. The materials of the folding portions 47A and 47B are configured with a thinner structure to allow each of the pressing buckles 42A, 42B to flip and fold easily, wherein each of the pressing buckles 42A, 42B forms an engaging block 421A, 421B thereon that is corresponding to the respective embedding grooves 43A, 43B. The upper end of each engaging blocks 421A, 421B is respectively a slightly enlarged portions 422A and 422B, wherein the engaging block 421A, 421B can forcefully pass through the corresponding neck portion 431A, 431B thereof to enter each of the corresponding gaps 432A, 432B and buckle up the corresponding first extending portion 51 or second extending portion 52 of the pouch 50, so as to affix the pouch 50 to the fixing member 40 when the corresponding pressing buckle 42A, 42B pivotally folds to clip at the corresponding embedding groove 43A, 43B thereof.

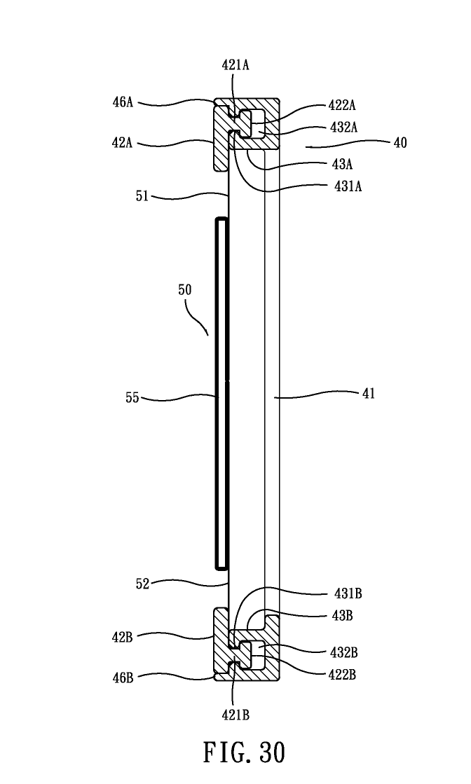

Meanwhile, the center through window 41 of the fixing member 40 will connect through the inlet of the pouch 50, as shown in FIGS. 7 to 11. The bag body 501 of the pouch 50 is guided to be folded via a flat folding board 90 have a predetermined width by firstly aligning with the bottom rim of the bag body 501, and secondly using the folding board 90 with the bag body 501 to roll up one by one, so as to fold the bag 501 into a flat folded bag 55. Then remove the folding board 90 and make the width of the folded bag 55 between the upper and lower rim of the center through window 41 (as shown in FIGS. 30 and 31).

Refer to FIGS. 31 to 35, the dog excrement collector 200 of the present invention comprises a wearable toilet 100, a fixing member 40, and a pouch 50, wherein the structural features of the wearable toilet 100, fixing member 40, and pouch 50 have introduced above, so they will not be described again. The following is going to describe the method of assembling, method of using, and effects produced of the automatic dog dog excrement collector 200.

First, the covering member 30 is flipped downwardly such that the fixing member 40 and the pouch 50 insert to the slots 11A, 11B from the place of the opening 13 of the junction member 10 until the stopping edge 44 of the fixing member 40 lean against the wall 14. Therefore, the folded bag 55 is retained within the junction member 10 and the through hole 15 connects through the center through window 41 of the fixing member 40 as well as the inlet 53 of the pouch 50 (as shown in FIG. 32), wherein the inlet 53 of the pouch 50 is slightly closed when the folded bag 55 of the pouch 50 is folded. As the fixing member 40 and the pouch 50 have inserted into the junction member 10, the covering member 30 is covered to the original position thereof, which the second attachment sheet 32A, 32B magnetically attach on the first attachment sheet 17A, 17B again and the covering member 30 can still cover and limit the folded bag 55 in between the junction member 10 and the covering member 30, so as to retain the folded bag 55 in between the junction member 10 and the covering member 30 without falling out when there is no external force (as shown FIG. 33).

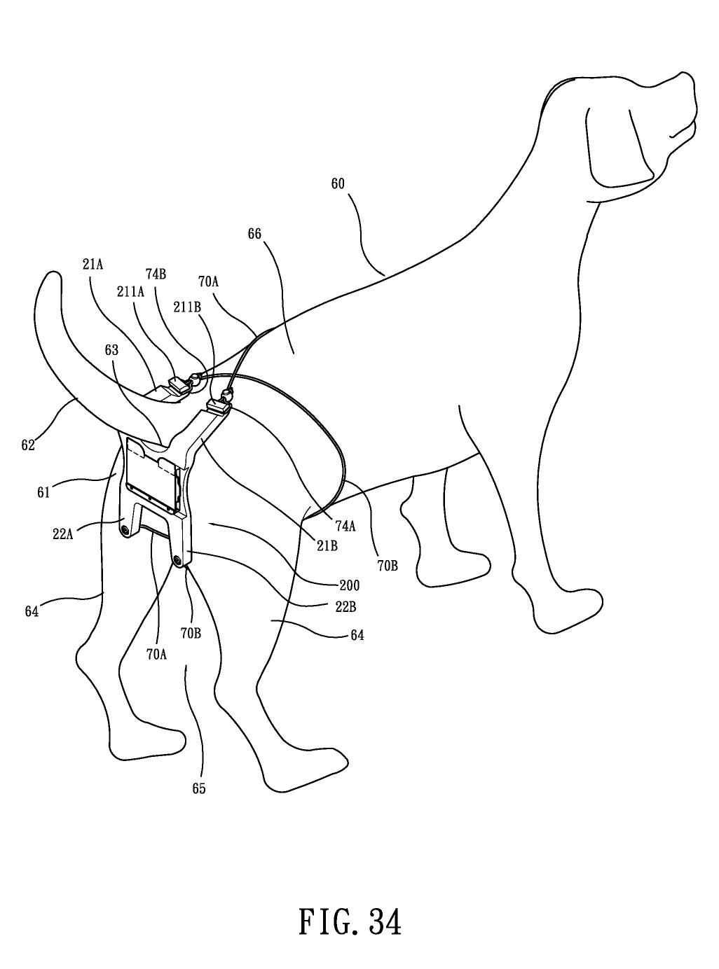

As shown in FIG. 34, the dog excrement collector 200 may use the two carrying belts 70A, 70B to pass through the groin 65 between the two hinds 64 of the dog, then extend to cross on the dog's back 66, and hook on the opposite barb blocks 211B, 211A, so as to wear the dog excrement collector 200 on the dog, which also lets the soft pad body 20 at the inner side of the wearable toilet 100 to lean on the butt 61 of the dog 60, and the bottom rim of the first recess 23 of the pad body 20 allows the root 63 of the dog's tail 62 to rest and lean on. The through hole 15 that connects through the pad body 20 and the junction member 10 can also constantly keep aligning with the anus of the dog 60. Each of the first pad extending portions 21A, 21B of the pad body 20 and each of the second pad extending portions 22A, 22B can both be bent by external force to deform the shape differently so as to closely align with the dog's back 66 and the inner sides of the two hinds 64. Also, the two carrying belts 70A, 70B are correspondingly crossly hook and connect on the dog's back 66, so as to have the dog excrement collector 200 achieve excellent fit and be unlikely to have large shift. Meanwhile, the flat design will not destroy the appearance of the dog's shape as the dog wears it. Also it will not affect the dog's regular activities, including activities like sitting, groveling, standing, and running.

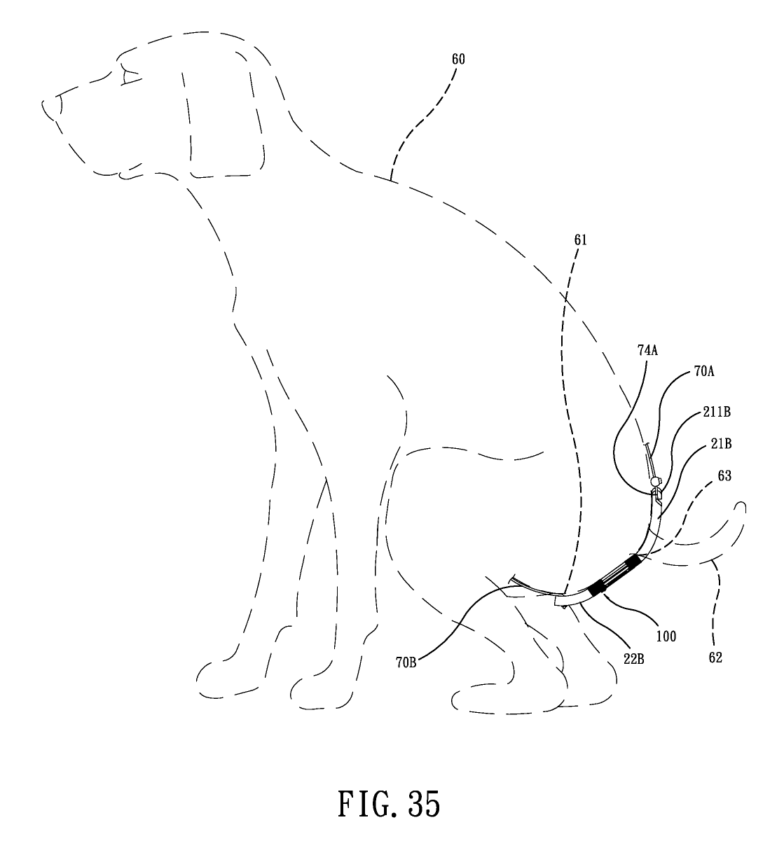

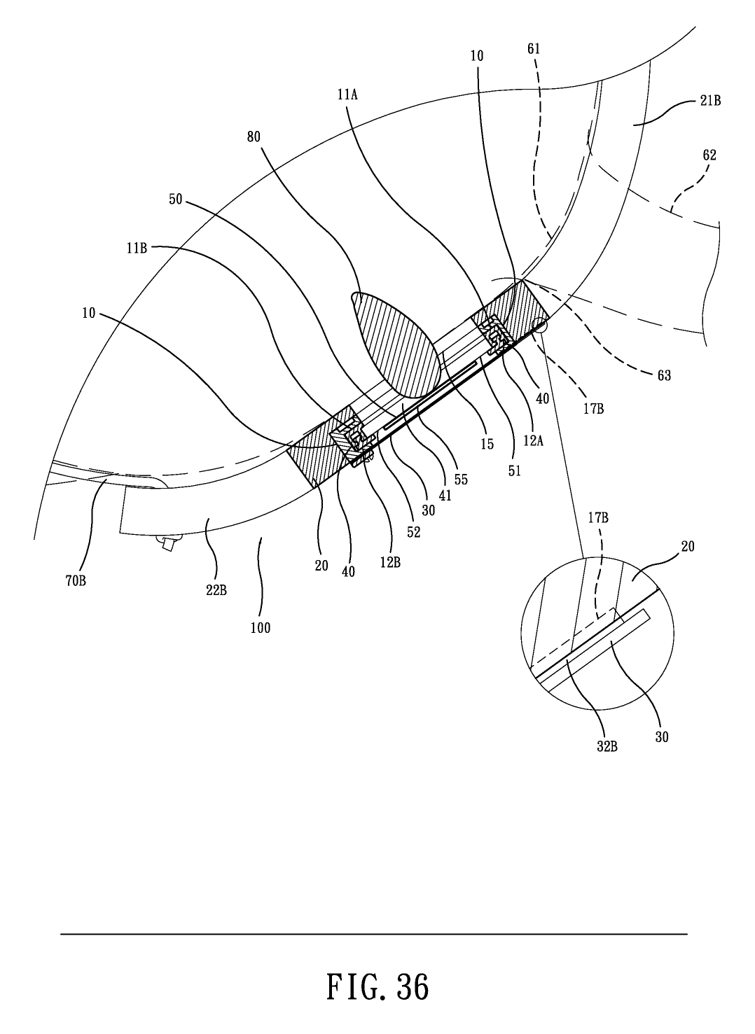

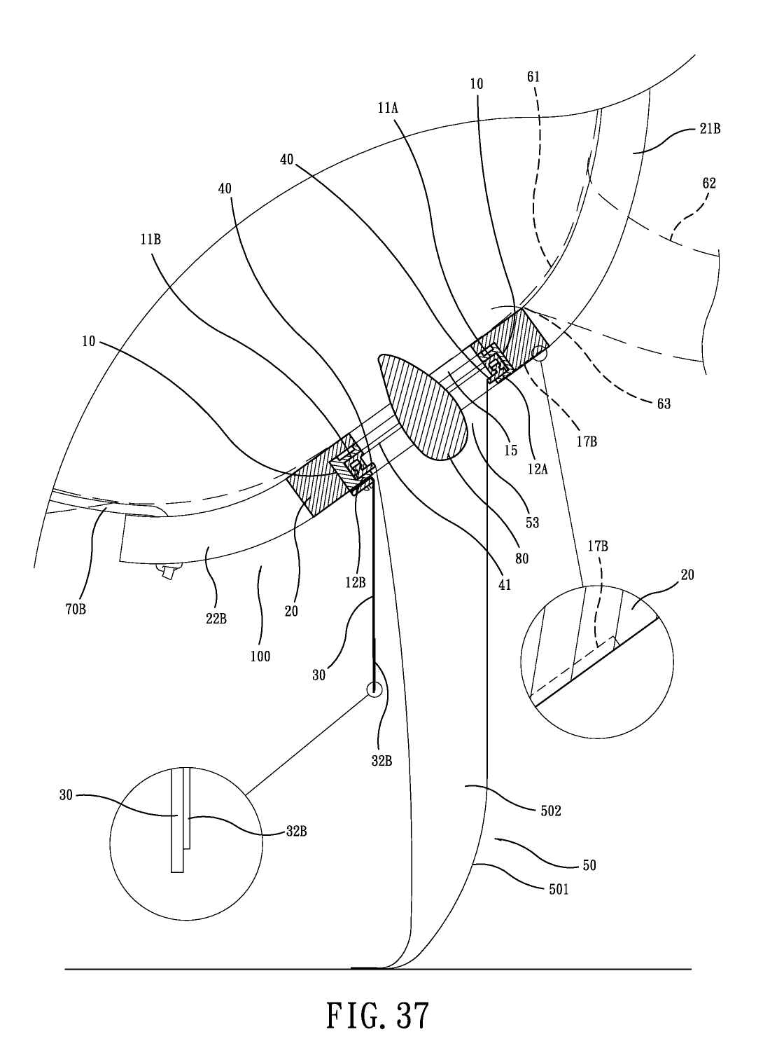

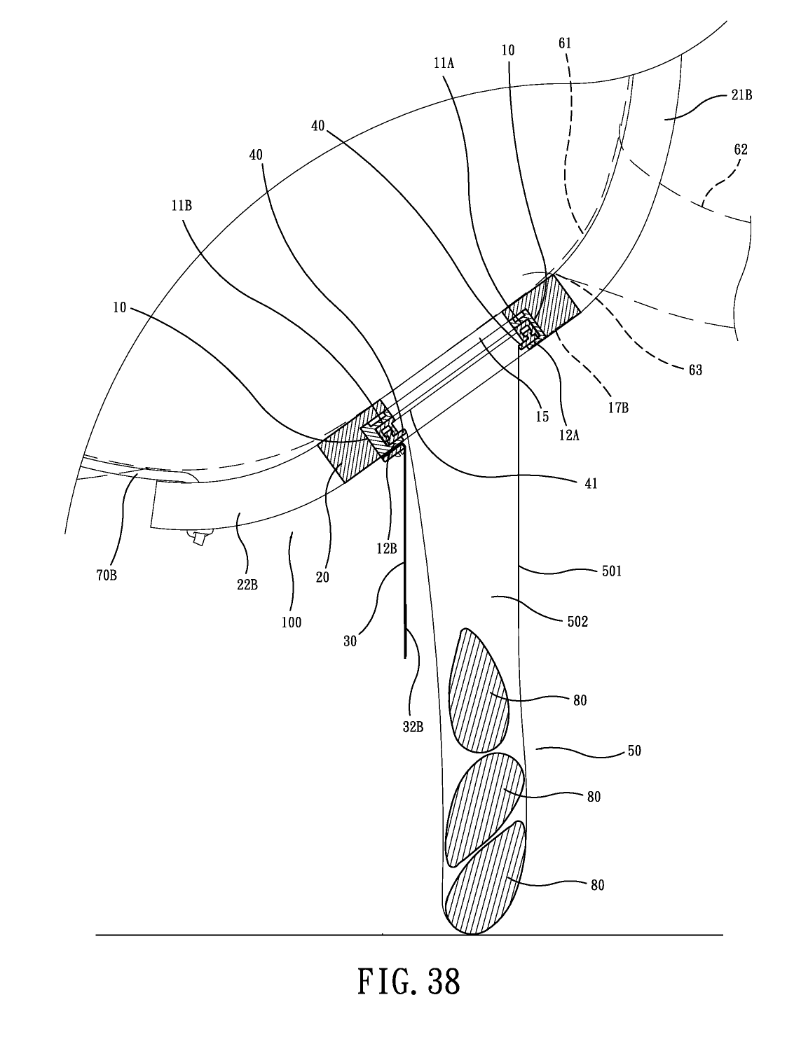

Referring to FIGS. 35 to 38, when a dog 60 is about to defecate, the dog, as an usual action of a dog 60, arches its back 66 for further push, and its butt 61 will also turn to face the ground in an angle. Meanwhile, the pad body 20 and the junction member 10 will be shifted via the dog's butt 61 to face the ground in an angle. Although the dog's shape has been somewhat changed, with the flexibly extended carrying belts 71F, 72F, the through hole 15 of the pad body 20 can constantly align to the anus of the dog 60 without shifting. When there is no external force, the covering member 30 can still cover on the junction member 10 and restrict the folded bag 55 of the pouch 50 in between the junction member 10 and the covering member 30 with the engagement between each second attachment sheet (32A), 32B and the corresponding first attachment sheet (17A), 17B thereof. As the dog dropping goes out, it instantly passes the through hole 15 of the junction member 10 and the pad body 20, and the center through window 41 of the fixing member 40, and immediately pushes to the folded bag 55 and simultaneously pushes to the covering member 30. Because the gravity force of the dog dropping 80 is greater than the engagement between the first attachment sheet (17A), 17B and the second attachment sheet (32A), 32B, the top rim of the covering member 30 will be open outwardly and droop. As a result, the folded bag 55 due to the gravity will naturally deploy down to a strip, wherein the inlet 53 of the bag body 501 will be pushed by the dog dropping 80, so that the first extending portion 51 and the second extending portion 52, which have originally been closed, will automatically open, so as to allow the continuously falling dog droppings 80 to drop into the accommodating space 502 of the bag body 501 by gravity. Also, by the blocking of the two retaining walls 12A, 12B opposite to the upper and lower margins of the fixing member 40, the entire of the fixing member 40 and the pouch 50 will be suspendedly hung without detaching from fixing member 40. When the dog 60 completely finishes defecating, the fixing member 40 with the pouch 50 that has received dog droppings 80 can then be taken out. Then to insert a prepared fixing member 40 that has coupled to the folded bag 55 and to cover the covering member 30 on the junction member 10, so that each second attachment sheet (32A), 32B can re-couple to the corresponding first attachment sheet (17A), 17B again, allows the next use of defecation.

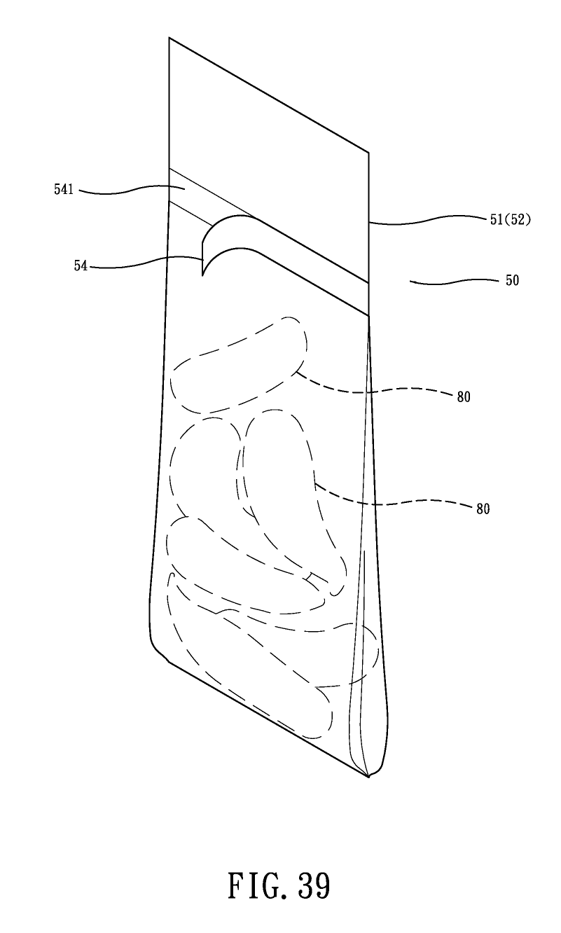

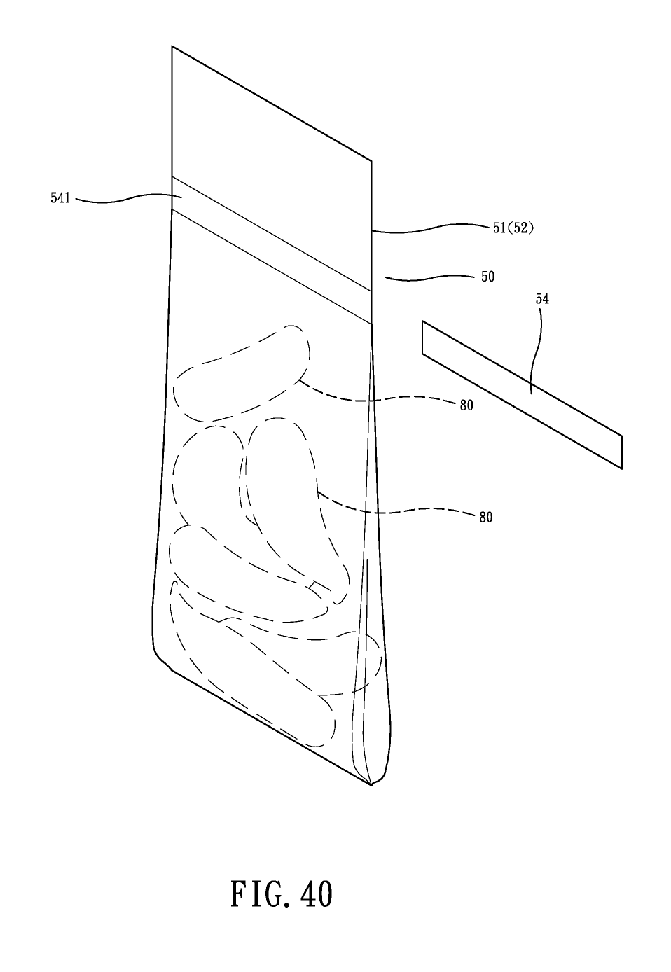

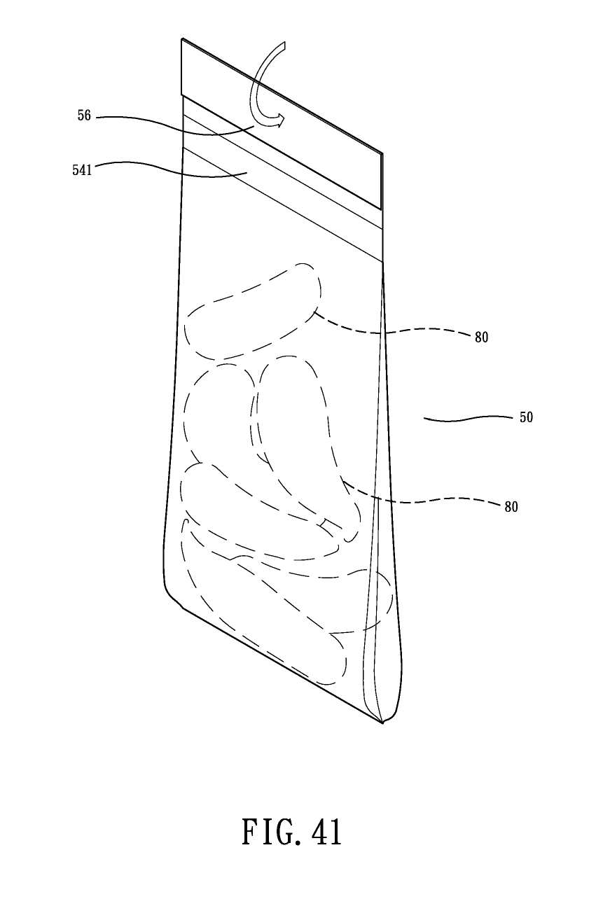

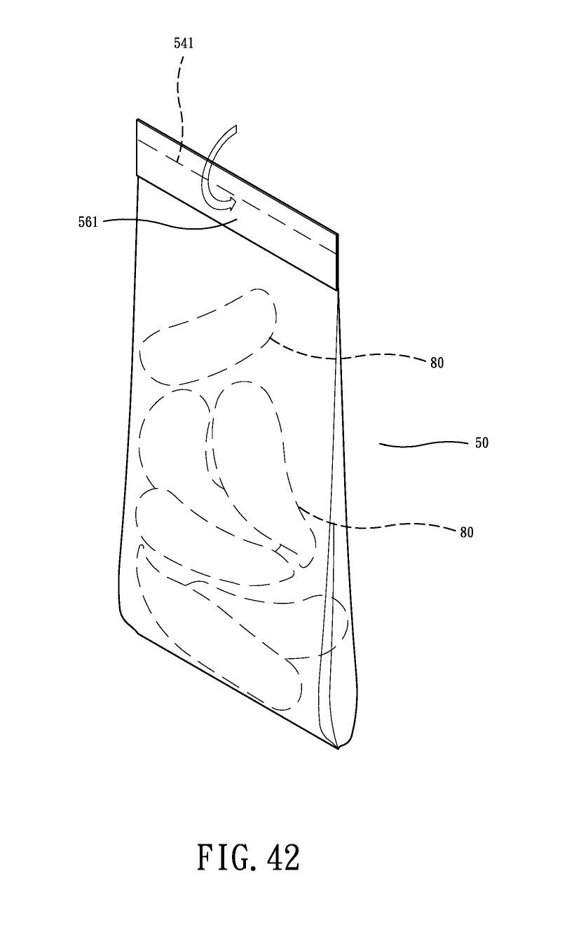

As shown in FIGS. 39 to 42, the pouch 50 that received dog dropping 80 is unloaded from the fixing member 40. The first extending portion 51 and the second extending portion 52 can be coupled with each other via glue. Then, by removing the self-adhesive tape 54 to expose the adhesive layer 541 at a lower layer, the first extending portion 51 and the second extending portion 52 are folded together and coupled with each other via the adhesive layer 541 to form a first flap 56. Then, the first flap 56 further folded to the side of the adhesive layer 541 to attach them to form a second flap 561. The second flap 561 is glued on the adhesive layer 541, so as to seal the opening of the pouch 50 in order to prevent the smell of the dog dropping 80 from diffusing. Later, the sealed pouch 50 can be discarded in a garbage can designated for collecting dog dropping 80.

All in all, based on the above description, the present invention directly wears a dog excrement collector on a dog, uses the covering member with the magnetic force to retain the folded pouch in between the junction member and covering member without deploying, and allows the dog wearing the dog excrement collector to be able to normally sit, stand, grovel, or conduct other regular activities, and keep the appearance of the dog at the same time. Besides, when the dog defecates, the covering member will be forced to open by the gravity of the dog dropping than the magnetic attraction between the first magnetic film and the second magnetic film, so that the pouch may naturally drop to unfold and exactly allow the dog droppings to enter and store in the pouch.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A dog excrement collector for a dog, comprising:
a wearable toilet adapted for being worn by said dog, wherein said wearable toilet has a pad through window arranged for being aligned with an anus of said dog; and
a pouch comprising a bag body detachably held by said wearable toilet, wherein said bag body has an inlet aligned with said pad through window for receiving and collecting dog's droppings in said bag body by gravity, such that said bag body is detached from said wearable toilet and is sealed at said inlet after said dog's droppings are collected.

2. The dog excrement collector, as recited in claim 1, wherein said wearable toilet comprising a pad body defining said pad through window thereat, one or more carrying belts extended from said pad body for being carried by said dog, and a covering member, having a top rim affixed to said pad body and a bottom rim serving as a free edge, for covering said pad through window and for retaining said bag body between said covering member and said pad body, wherein said wearable toilet further comprises a second magnetic film provided at said free edge of said covering member and a first magnetic film provided at said pad body to magnetically engage with said first magnetic film, so as to retain said covering member to cover at said pad through window.

3. The dog excrement collector, as recited in claim 2, wherein said pouch further comprises a pouch retention frame having a pouch through hole and affixed to said bag body to align said inlet of said bag body with said pouch through hole, wherein said pouch retention frame is detachably coupled at said pad body to detachably retain said bag body between said pad body and said covering member.

4. The dog excrement collector, as recited in claim 3, wherein said bag body further has two pouch extending portions opposedly extended from said inlet of bag body, wherein said pouch extending portions of said bag body are adhered to said pouch retention frame to ensure said pouch through hole to be aligned with said inlet of said bag body.

5. The dog excrement collector, as recited in claim 3, wherein said bag body further has two pouch extending portions opposedly extended from said inlet of bag body, wherein said pouch retention frame comprises two foldable pressing buckles being pivotally folded to clip at said pouch extending portions, so as to ensure said pouch through hole to be aligned with said inlet of said bag body.

6. The dog excrement collector, as recited in claim 3, wherein said wearable toilet further comprises a retention member provided between said bag body and said covering member, wherein said retention member has a retention notch aligned with said pad through window, a first slot formed at a top edge of said retention notch and said pad body, and a second slot formed at a bottom edge of said retention notch and said pad body, wherein said pouch retention frame are slidably coupled between said first and second slots to detachably couple with said wearable toilet.

7. The dog excrement collector, as recited in claim 2, wherein said bag body has an elongated structure and is overlappedly folded flat to be retained between said pad body and said covering member, wherein said bag body is unfolded for receiving and collecting said dog's droppings by the gravity thereof.

8. The dog excrement collector, as recited in claim 1, wherein said pad body has two spaced apart first pad extending portions integrally and upwardly extended from a top edge of said pad body, wherein a pad recess is defined between said first pad extending portions for allowing a root of the dog's tail to rest at said pad recess when said dog wears said wearable toilet.

9. The dog excrement collector, as recited in claim 1, wherein said bag body has a plurality of folding lines spacedly provided at said bag body between a top opening and a bottom edge, such that said bag body are overlappedly and evenly folded between said top opening and said bottom edge to reduce an overall size for fitting to said wearable toilet.

10. A dog excrement collector for a dog, comprising a wearable toilet adapted for being worn by said dog, wherein said wearable toilet comprises a pad body defining a pad through window thereat, one or more carrying belts extended from said pad body for being carried by said dog, and a covering member, having a top rim affixed to said pad body and a bottom rim serving as a free edge, for covering said pad through window, wherein said wearable toilet is arranged for retaining a bag body between said covering member and said pad body and for detachably holding said bag body at a position that an inlet of said body is aligned with said pad through window not only to receive and collect dog's droppings in said bag body by gravity but also to enable said bag body to be detached from said wearable toilet and sealed at said inlet after said dog's droppings are collected.

11. The dog excrement collector, as recited in claim 10, wherein said wearable toilet further comprises a second magnetic film provided at said free edge of said covering member and a first magnetic film provided at said pad body to magnetically engage with said first magnetic film, so as to retain said covering member to cover at said pad through window.

12. The dog excrement collector, as recited in claim 11, further comprising a pouch retention frame, having a pouch through hole, for affixing to said bag body to align said inlet of said bag body with said pouch through hole so as to enable said bag body to be detachably retained between said pad body and said covering member.

13. A method of collecting dog's droppings by a dog excrement collector, comprising the steps of:
(a) wearing a wearable toilet on a dog at a position that a pad through window of said wearable toilet is aligned with an anus of said dog;
(b) detachably holding a bag body by said wearable toilet at a position that an inlet of said bag body is aligned with said pad through window of said wearable toilet;
(c) when the dog is defecating, receiving and collecting dog's droppings in said bag body by gravity; and
(d) detaching said bag body from said wearable toilet and sealing said inlet of said bag body after said dog's droppings are collected.

14. The method as recited in claim 13 wherein, in said step (b), said bag body is overlapped folded flat to be retained at said wearable toilet and is unfolded by the gravity of said dog's droppings.

15. The method, as recited in claim 13, wherein the step (a) further comprises a step of (a.1) providing a covering to cover said pad through window and to retain said bag body between said covering member and said pad body, such that covering member normally covers said pad through window to hide said bag body and unfolds to expose said bag body by the gravity of said dog's droppings.

16. The method, as recited in claim 13, wherein the step (a) further comprises the steps of:
(a.2) providing a second magnetic film provided at said free edge of said covering member; and
(a.3) providing a first magnetic film provided at said pad body to magnetically engage with said second magnetic film, so as to retain said covering member to cover at said pad through window.

17. The method, as recited in claim 13, wherein the step (b) further comprises a step of providing a pouch retention frame to affix to said bag body at a position that pouch through hole of said pouch retention frame is aligned with said inlet of said bag body, wherein said pouch retention frame is detachably coupled at said pad body to detachably retain said bag body at said pad body.

18. The method, as recited in claim 17, wherein said pouch retention frame is slidably engaged with said pad body.

19. The method as recited in claim 13 wherein, in said step (a), said pad body has two spaced apart first pad extending portions integrally and upwardly extended from a top edge of said pad body, wherein a pad recess is defined between said first pad extending portions for allowing a root of the dog's tail to rest at said pad recess when said dog wears said wearable toilet.

20. The method as recited in claim 13 wherein, in said step (a), said dog wears said pad body by one or more carrying belts extended from said pad body.

21. A pouch, which is a strip bag with the bottom and two sides sealed and inside thereof forming an accommodating space that has an inlet on top, wherein two sides of the inlet each respectively forms a first pouch extending portion and a second pouch extending portion without connection in between; an external side of the bag was set a self-adhesive tape and external surface of the bag corresponding to said self-adhesive tape was coated an adhesive layer.

22. The pouch, as recited in claim 21, wherein said first pouch extending portion and said second first pouch extending portion are adhered to a pouch retention frame which is a sheet having a central through hole, wherein more than one foldable pressing buckles extend from the external margins of said pouch retention frame, each pressing buckle can fold and clip on said pouch retention frame, wherein each opposite surface of each said pressing buckle and said pouch retention frame forms clipable engaging block and embedding groove.

23. The pouch, as recited in claim 22, wherein inserting end of each said embedding groove forms a neck portion with reduced diameter and inside of each embedding groove forms a gap; upper end of each said engaging block was made slightly expanded as an enlarged portion.
